(19) United States
(12) Patent Application Publication
(10) Pub. No.: US 2025/0267708 A1
(43) Pub. Date: Aug. 21, 2025

(54) MULTI-AP TRANSMISSION SCHEME SELECTION

(71) Applicant: Ofinno, LLC, Reston, VA (US)

(72) Inventors: Jiayi Zhang, Rockville, MD (US); Jeongki Kim, Fairfax, VA (US); Esmael Hejazi Dinan, McLean, VA (US); Leonardo Alisasis Lanante, Reston, VA (US)

(73) Assignee: Ofinno, LLC, Reston, VA (US)

(21) Appl. No.: 19/188,600

(22) Filed: Apr. 24, 2025

Related U.S. Application Data
(63) Continuation of application No. PCT/US2023/035767, filed on Oct. 24, 2023.
(60) Provisional application No. 63/419,357, filed on Oct. 26, 2022.

(51) Int. Cl. H04W 74/0816; H04W 74/00; H04W 74/04

(52) U.S. Cl. CPC H04W 74/0816; H04W 74/002; H04W 74/04

(57) ABSTRACT

A first access point (AP) receives from a second AP a first frame comprising an indication of a first multi-AP transmission scheme for use in a coordinated AP set comprising the first AP and the second AP. The first AP transmits a second frame announcing a second multi-AP transmission scheme determined based on the first multi-AP transmission scheme indicated in the first frame. The first multi-AP transmission scheme may correspond to a preferred scheme for the second AP for use in the coordinated AP set.

### CROSS-REFERENCE TO RELATED APPLICATIONS

This application is a continuation of International Application No. PCT/US2023/035767, filed Oct. 24, 2023, which claims the benefit of U.S. Provisional Application No. 63/419,357, filed Oct. 26, 2022, all of which are hereby incorporated by reference in their entireties.

### BRIEF DESCRIPTION OF THE DRAWINGS

Examples of several of the various embodiments of the present disclosure are described herein with reference to the drawings.

FIG. 1 illustrates example wireless communication networks in which embodiments of the present disclosure may be implemented.

FIG. 2 is a block diagram illustrating example implementations of a station (STA) and an access point (AP).

FIG. 3 illustrates an example of a Medium Access Control (MAC) frame format.

FIG. 4A illustrates an example of a management frame format.

FIG. 4B illustrates an example EHT Operation element format.

FIG. 5A illustrates an example of a management frame used as an action frame.

FIG. 5B illustrates an example public action frame format.

FIG. 6 illustrates an example of a Quality of Service (QoS) null frame.

FIG. 7 illustrates an example multi-AP network.

FIGS. 8A-8B illustrate another two examples of multi-AP networks.

FIG. 9 illustrates an example multi-AP operation procedure.

FIG. 10 illustrates an example multi-AP information exchange phase.

FIG. 11 illustrates an example multi-AP sounding phase.

FIG. 12 illustrates an example multi-AP selection phase.

FIG. 13 illustrates an example multi-AP data sharing phase.

FIG. 14 illustrates an example multi-AP data transmission phase.

FIG. 15 is an example that illustrates a problem that may arise in multi-AP operation using the procedure illustrated in FIG. 9.

FIG. 16 illustrates an example of frame exchanges including preferred multi-AP transmission scheme information for a coordinated AP set.

FIG. 17 illustrates another example of frame exchanges including preferred multi-AP transmission scheme information for a coordinated AP set.

FIGS. 18A-18B illustrate two example mappings for preferred multi-AP transmission scheme information.

FIG. 19 illustrates an example of a beacon frame including preferred multi-AP transmission scheme information.

FIG. 20 illustrate examples of frame exchanges using action frames including preferred multi-AP transmission scheme information.

FIG. 21 illustrates an example of frame exchanges using a data frame including preferred multi-AP transmission scheme information.

FIG. 22 illustrates an example procedure which may be used to carry out a multi-AP operation according to an embodiment.

FIG. 23 illustrates another example procedure which may be used to carry out a multi-AP operation according to an embodiment.

FIG. 24 illustrates another example procedure which may be used to carry out a multi-AP operation according to an embodiment.

FIG. 25 illustrates another example procedure which may be used to carry out a multi-AP operation according to an embodiment.

FIG. 26 illustrates another example procedure which may be used to carry out a multi-AP operation according to an embodiment.

FIG. 27 illustrates an example process according to an embodiment.

FIG. 28 illustrates an example process according to an embodiment.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. After reading the description, it will be apparent to one skilled in the relevant art how to implement alternative embodiments. The present embodiments may not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a station, an access point, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, may be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={STA1, STA2} are: {STA1}, {STA2}, and {STA1, STA2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages/frames comprise a plurality of parameters, it implies that a parameter in the plurality of parameters is in at least one of the one or more messages/frames but does not have to be in each of the one or more messages/frames.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g., hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

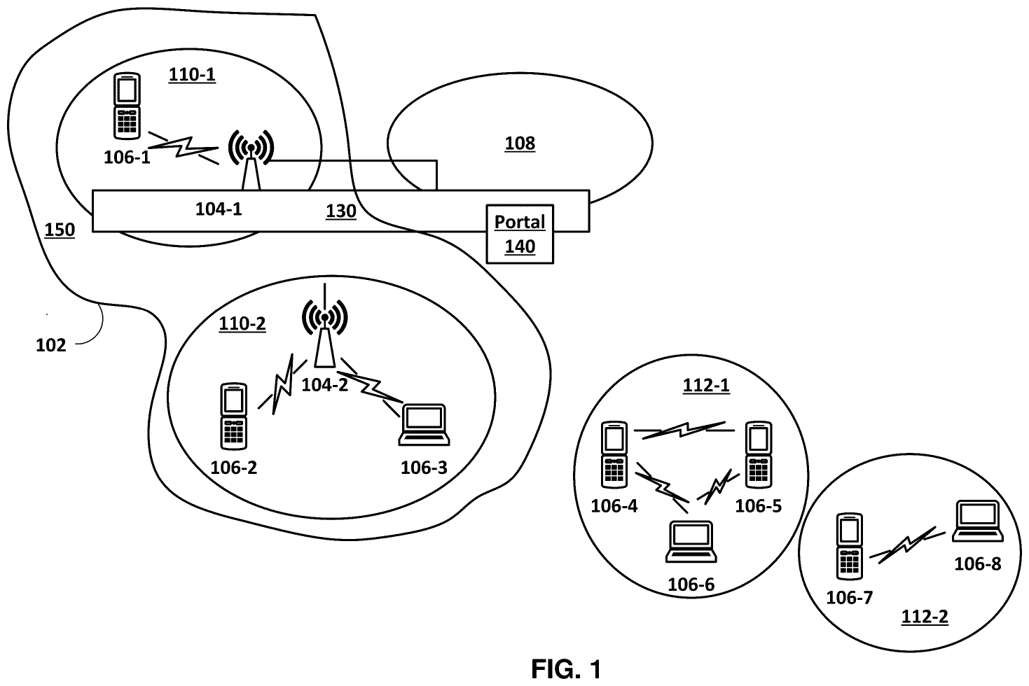

FIG. 1 illustrates example wireless communication networks in which embodiments of the present disclosure may be implemented.

As shown in FIG. 1, the example wireless communication networks may include an Institute of Electrical and Electronic Engineers (IEEE) 802.11 (WLAN) infra-structure network 102. WLAN infra-structure network 102 may include one or more basic service sets (BSSs) 110 and 120 and a distribution system (DS) 130.

BSS 110-1 and 110-2 each includes a set of an access point (AP or AP STA) and at least one station (STA or non-AP STA). For example, BSS 110-1 includes an AP 104-1 and a STA 106-1, and BSS 110-2 includes an AP 104-2 and STAs 106-2 and 106-3. The AP and the at least one STA in a BSS perform an association procedure to communicate with each other.

DS 130 may be configured to connect BSS 110-1 and BSS 110-2. As such, DS 130 may enable an extended service set (ESS) 150. Within ESS 150, APs 104-1 and 104-2 are connected via DS 130 and may have the same service set identification (SSID).

WLAN infra-structure network 102 may be coupled to one or more external networks. For example, as shown in FIG. 1, WLAN infra-structure network 102 may be connected to another network 108 (e.g., 802.X) via a portal 140. Portal 140 may function as a bridge connecting DS 130 of WLAN infra-structure network 102 with the other network 108.

The example wireless communication networks illustrated in FIG. 1 may further include one or more ad-hoc networks or independent BSSs (IBSSs). An ad-hoc network or IBSS is a network that includes a plurality of STAs that are within communication range of each other. The plurality of STAs are configured so that they may communicate with each other using direct peer-to-peer communication (i.e., not via an AP).

For example, in FIG. 1, STAs 106-4, 106-5, and 106-6 may be configured to form a first IBSS 112-1. Similarly, STAs 106-7 and 106-8 may be configured to form a second IBSS 112-2. Since an IBSS does not include an AP, it does not include a centralized management entity. Rather, STAs within an IBSS are managed in a distributed manner. STAs forming an IBSS may be fixed or mobile.

A STA as a predetermined functional medium may include a medium access control (MAC) layer that complies with an IEEE 802.11 standard. A physical layer interface for a radio medium may be used among the APs and the non-AP stations (STAs). The STA may also be referred to using various other terms, including mobile terminal, wireless device, wireless transmit/receive unit (WTRU), user equipment (UE), mobile station (MS), mobile subscriber unit, or user. For example, the term “user” may be used to denote a STA participating in uplink Multi-user Multiple Input, Multiple Output (MU MIMO) and/or uplink Orthogonal Frequency Division Multiple Access (OFDMA) transmission.

A physical layer (PHY) protocol data unit (PPDU) may be a composite structure that includes a PHY preamble and a payload in the form of a PHY service data unit (PSDU). For example, the PSDU may include a PHY preamble and header and/or one or more MAC protocol data units (MPDUs). The information provided in the PHY preamble may be used by a receiving device to decode the subsequent data in the PSDU. In instances in which PPDUs are transmitted over a bonded channel (channel formed through channel bonding), the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

A frequency band may include one or more sub-bands or frequency channels. For example, PPDUs conforming to the IEEE 802.11n, 802.11ac, 802.11ax and/or 802.11be standard amendments may be transmitted over the 2.4 GHz, 5 GHz, and/or 6 GHz bands, each of which may be divided into multiple 20 MHz channels. The PPDUs may be transmitted over a physical channel having a minimum bandwidth of 20 MHz. Larger channels may be formed through channel bonding. For example, PPDUs may be transmitted over physical channels having bandwidths of 40 MHz, 80 MHz, 160 MHz, or 320 MHz by bonding together multiple 20 MHz channels.

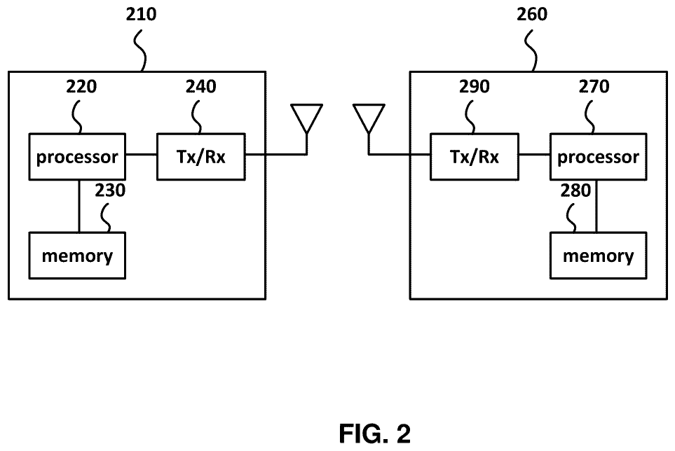

FIG. 2 is a block diagram illustrating example implementations of a STA 210 and an AP 260. As shown in FIG. 2, STA 210 may include at least one processor 220, a memory 230, and at least one transceiver 240. AP 260 may include at least one processor 270, a memory 280, and at least one transceiver 290. Processor 220/270 may be operatively connected to memory 230/280 and/or to transceiver 240/290.

Processor 220/270 may implement functions of the PHY layer, the MAC layer, and/or the logical link control (LLC) layer of the corresponding device (STA 210 or AP 260). Processor 220/270 may include one or more processors and/or one or more controllers. The one or more processors and/or one or more controllers may comprise, for example, a general-purpose processor, a digital signal processor (DSP), a microcontroller, an application specific integrated circuit (ASIC), a field programmable gate array (FPGA), a logic circuit, or a chipset, for example.

Memory 230/280 may include a read-only memory (ROM), a random-access memory (RAM), a flash memory, a memory card, a storage medium, and/or other storage unit. Memory 230/280 may comprise one or more non-transitory computer readable mediums. Memory 230/280 may store computer program instructions or code that may be executed by processor 220/270 to carry out one or more of the operations/embodiments discussed in the present application. Memory 230/280 may be implemented (or positioned) within processor 220/270 or external to processor 220/270. Memory 230/280 may be operatively connected to processor 220/270 via various means known in the art.

Transceiver 240/290 may be configured to transmit/receive radio signals. In an embodiment, transceiver 240/290 may implement a PHY layer of the corresponding device (STA 210 or AP 260). In an embodiment, STA 210 and/or AP 260 may be a multi-link device (MLD), that is a device capable of operating over multiple links as defined by the IEEE 802.11 standard. As such, STA 210 and/or AP 260 may each implement multiple PHY layers. The multiple PHY layers may be implemented using one or more of transceivers 240/290.

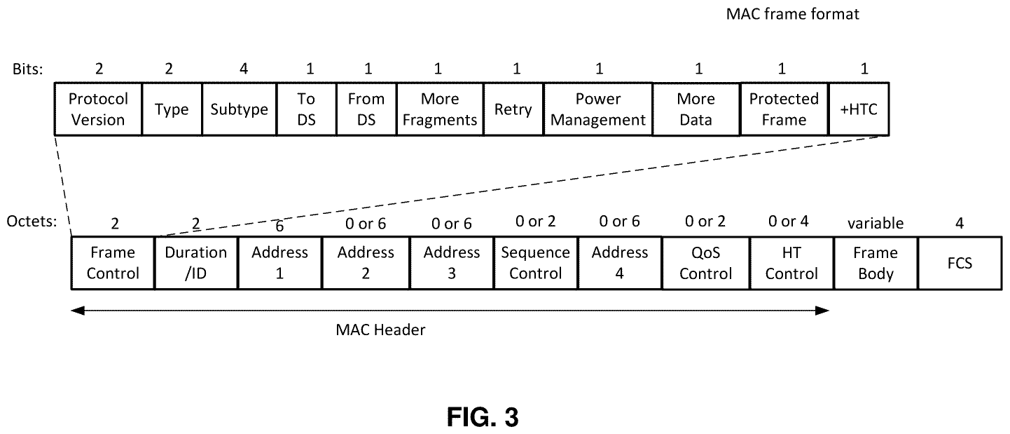

FIG. 3 illustrates an example format of a MAC frame. In operation, a STA may construct a subset of MAC frames for transmission and may decode a subset of received MAC frames upon validation. The particular subsets of frames that a STA may construct and/or decode may be determined by the functions supported by the STA. A STA may validate a received MAC frame using the frame check sequence (FCS) contained in the frame and may interpret certain fields from the MAC headers of all frames.

As shown in FIG. 3, a MAC frame includes a MAC header, a variable length frame body, and a frame check sequence (FCS).

The MAC header includes a frame control field, an optional duration/ID field, address fields, an optional sequence control field, an optional QoS control field, and an optional HT control field.

The frame control field includes the following subfields: protocol version, type, subtype, To DS, From DS, more fragments, retry, power management, more data, protected frame, and +HTC.

The protocol version subfield is invariant in size and placement across all revisions of the IEEE 802.11 standard. The value of the protocol version subfield is 0 for MAC frames.

The type and subtype subfields together identify the function of the MAC frame. There are three frame types: control, data, and management. Each of the frame types has several defined subtypes. Bits within the subtype subfield are used to indicate a specific modification of the basic data frame (subtype 0). For example, in data frames, the most significant bit (MSB) of the subtype subfield, bit 7 (B7) of the frame control field, is defined as the QoS subfield. When the QoS subfield is set to 1, it indicates a QoS subtype data frame, which is a data frame that contains a QoS control field in its MAC header. The second MSB of the subtype field, bit 6 (B6) of the frame control field, when set to 1 in data subtypes, indicates a data frame that contain no frame body field.

The To DS subfield indicates whether a data frame is destined to the distribution system (DS). The From DS subfield indicates whether a data frame originates from the DS.

The more fragments subfield is set to 1 in all data or management frames that have another fragment to follow of the MAC service data unit (MSDU) or MAC management protocol data unit (MMPDU) carried by the MAC frame. It is set to 0 in all other frames in which the more fragments subfield is present.

The retry subfield is set to 1 in any data or management frame that is a retransmission of an earlier frame. It is set to 0 in all other frames in which the retry subfield is present. A receiving STA uses this indication to aid it in the process of eliminating duplicate frames. These rules do not apply for frames sent by a STA under a block agreement.

The power management subfield is used to indicate the power management mode of a STA.

The More Data subfield indicates to a STA in power save (PS) mode that bufferable units (BUs) are buffered for that STA at the AP. The more data subfield is valid in individually addressed data or management frames transmitted by an AP to a STA in PS mode. The more data subfield is set to 1 to indicate that at least one additional buffered BU is present for the STA.

The protected frame subfield is set to 1 if the frame body field contains information that has been processed by a cryptographic encapsulation algorithm.

The +HTC subfield indicates that the MAC frame contains an HT control field.

The duration/ID field of the MAC header indicates various contents depending on frame type and subtype and the QoS capabilities of the sending STA. For example, in control frames of the power save poll (PS-Poll) subtype, the duration/ID field carries an association identifier (AID) of the STA that transmitted the frame in the 14 least significant bits (LSB), and the 2 most significant bits (MSB) are both set to 1. In other frames sent by STAs, the duration/ID field contains a duration value (in microseconds) which is used by a recipient to update a network allocation vector (NAV). The NAV is a counter that it indicates to a STA an amount of time during which it must defer from accessing the shared medium.

There can be up to four address fields in the MAC frame format. These fields are used to indicate the basic service set identifier (BSSID), source address (SA), destination address (DA), transmitting address (TA), and receiving address (RA). Certain frames might not contain some of the address fields. Certain address field usage may be specified by the relative position of the address field (1-4) within the MAC header, independent of the type of address present in that field. Specifically, the address 1 field always identifies the intended receiver(s) of the frame, and the address 2 field, where present, always identifies the transmitter of the frame.

The sequence control field includes two subfields, a sequence number subfield and a fragment number subfield. The sequence number subfield in data frames indicates the sequence number of the MSDU (if not in an Aggregated MSDU (A-MSDU)) or A-MSDU. The sequence number subfield in management frames indicates the sequence number of the frame. The fragment number subfield indicates the number of each fragment of an MSDU or MMPDU. The fragment number is set to 0 in the first or only fragment of an MSDU or MMPDU and is incremented by one for each successive fragment of that MSDU or MMPDU. The fragment number is set to 0 in a MAC protocol data unit (MPDU) containing an A-MSDU, or in an MPDU containing an MSDU or MMPDU that is not fragmented. The fragment number remains constant in all retransmissions of the fragment.

The QoS control field identifies the traffic category (TC) or traffic stream (TS) to which the MAC frame belongs. The QoS control field may also indicate various other QoS related, A-MSDU related, and mesh-related information about the frame. This information can vary by frame type, frame subtype, and type of transmitting STA. The QoS control field is present in all data frames in which the QoS subfield of the subtype subfield is equal to 1.

The HT control field is present in QoS data, QoS null, and management frames as determined by the +HTC subfield of the frame control field.

The frame body field is a variable length field that contains information specific to individual frame types and subtypes. It may include one or more MSDUs or MMPDUs. The minimum length of the frame body is 0 octets.

The FCS field contains a 32-bit Cyclic Redundancy Check (CRC) code. The FCS field value is calculated over all of the fields of the MAC header and the frame body field.

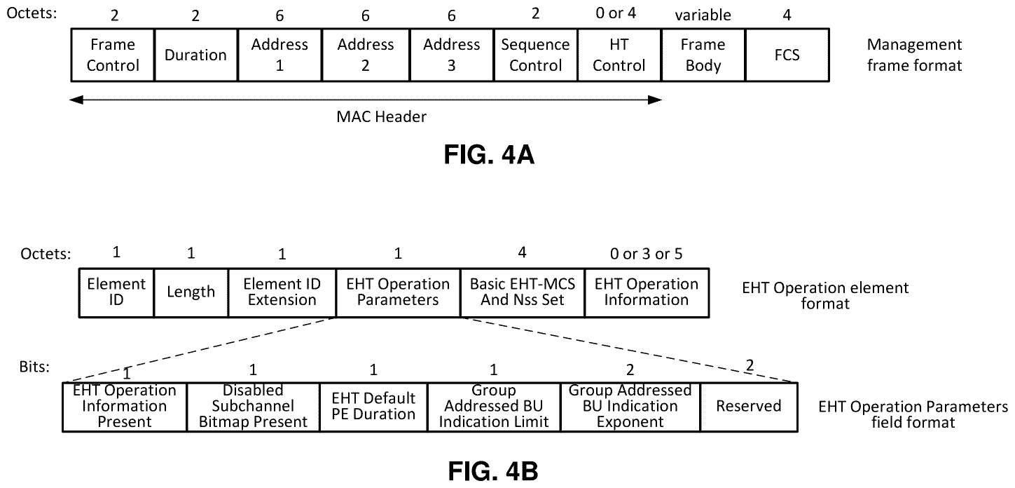

FIG. 4A illustrates an example of a management frame format. As shown in FIG. 4A, the management frame includes a MAC header, a variable length frame body, and a frame check sequence (FCS). The MAC header includes a frame control field, a duration field, an address 1 field, an address 2 field, an address 3 field, a sequence control field, and an optional HT control field. The presence of the HT control field is determined by the setting of a +HTC subfield of the frame control field.

In an example, the management frame becomes a beacon frame when a subtype field of the frame control field takes the value 1000. A frame body of the beacon frame includes the fields that are elements for operation of extreme high throughput (EHT) STAs. The operation of EHT STAs in an EHT basic service set (BSS) may be controlled by the following: a) an high throughput (HT) operation element, an high efficiency (HE) operation element, and an EHT operation element if operating in the 2.4 GHz band; b) the HT operation element, a very high throughput (VHT) operation element (if present), the HE operation element, and the EHT operation element if operating in the 5 GHz band.

FIG. 4B illustrates an example EHT Operation element format. As shown in FIG. 4B, the EHT operation element includes an element ID field, a Length field, an element ID extension field (if present), an EHT operation parameters field, a basic EHT-MCS and Nss set field, and an EHT operation information field. The EHT operation parameters field includes an EHT operation information present subfield, a disabled subchannel bitmap present subfield, an EHT default PE duration subfield, a group addressed BU indication limit, a group addressed BU indication exponent subfield, and a reserved subfield.

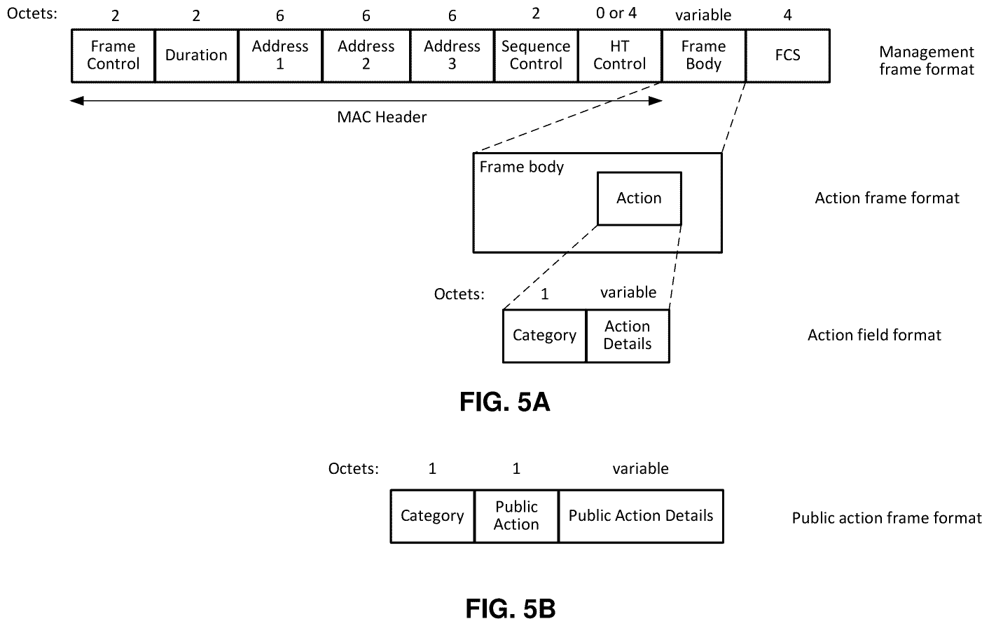

FIG. 5A illustrates an example of a management frame used as an action frame. As shown in FIG. 5A, when used as an action frame, the frame body of a management frame includes an action field that includes a category field and an action details field. The action field provides a mechanism for specifying extended management actions. The category field indicates a category of the action frame. When the category field is set to 4, the action frame is a public action frame. The public action frame may allow the following: a) Inter-basic service set (BSS) and AP to unassociated-STA communications; b) Intra-BSS communication; c) generic advertisement service (GAS). The action details field contains the details of the action, such as the public action details for a public action frame.

FIG. 5B illustrates an example public action frame format. As shown in FIG. 5B, the public action frame format includes a public action field, in the octet immediately after the category field, followed by a variable length public action details field.

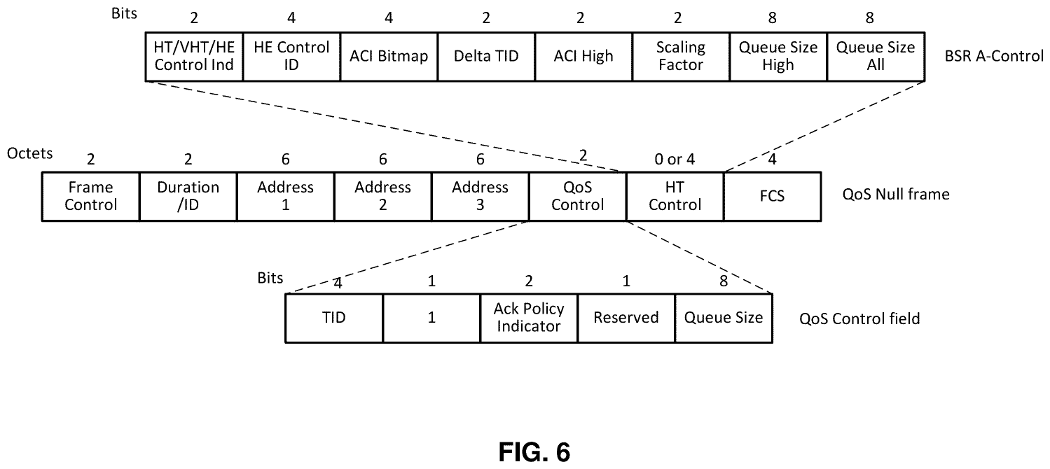

FIG. 6 illustrates an example of a QoS null frame indicating buffer status information. A QoS null frame refers to a QoS data frame with an empty frame body. A QoS null frame includes a QoS control field and an optional HT control field which may contain a buffer status report (BSR) control subfield. A QoS null frame indicating buffer status information may be transmitted by a STA to an AP.

The QoS control field may include a traffic identifier (TID) subfield, an ack policy indicator subfield, and a queue size subfield (or a transmission opportunity (TXOP) duration requested subfield).

The TID subfield identifies the TC or TS of traffic for which a TXOP is being requested, through the setting of the TXOP duration requested or queue size subfield. The encoding of the TID subfield depends on the access policy (e.g., Allowed value 0 to 7 for enhanced distributed channel access (EDCA) access policy to identify user priority for either TC or TS).

The ack policy indicator subfield, together with other information, identifies the acknowledgment policy followed upon delivery of the MPDU (e.g., normal ack, implicit block ack request, no ack, block ack, etc.)

The queue size subfield is an 8-bit field that indicates the amount of buffered traffic for a given TC or TS at the STA for transmission to the AP identified by the receiver address of the frame containing the subfield. The queue size subfield is present in QoS null frames sent by a STA when bit 4 of the QoS control field is set to 1. The AP may use information contained in the queue size subfield to determine the TXOP duration assigned to the STA or to determine the uplink (UL) resources assigned to the STA.

In a frame sent by or to a non-high efficiency (non-HE) STA, the following rules may apply to the queue size value:
The queue size value is the approximate total size, rounded up to the nearest multiple of 256 octets and expressed in units of 256 octets, of all MSDUs and A-MSDUs buffered at the STA (excluding the MSDU or A-MSDU contained in the present QoS Data frame) in the delivery queue used for MSDUs and A-MSDUs with TID values equal to the value indicated in the TID subfield of the QoS Control field.
A queue size value of 0 is used solely to indicate the absence of any buffered traffic in the queue used for the specified TID.
A queue size value of 254 is used for all sizes greater than 64 768 octets.
A queue size value of 255 is used to indicate an unspecified or unknown size.

In a frame sent by an HE STA to an HE AP, the following rules may apply to the queue size value.

The queue size value, QS, is the approximate total size in octets, of all MSDUs and A-MSDUs buffered at the STA (including the MSDUs or A-MSDUs contained in the same PSDU as the frame containing the queue size subfield) in the delivery queue used for MSDUs and A-MSDUs with TID values equal to the value indicated in the TID subfield of the QoS control field.

The queue size subfield includes a scaling factor subfield in bits B14-B15 of the QoS control field and an unscaled value, UV, in bits B8-B13 of the QoS control field. The scaling factor subfield provides the scaling factor, SF.

A STA obtains the queue size, QS, from a received QoS control field, which contains a scaling factor, SF, and an unscaled value, UV, as follows:

$$QS = 16 \times UV , if SF is equal to 0 ;$$

$$1024 + 256 \times UV , if SF is equal to 1 ;$$

$$17 \; 408 + 2048 \times UV , if SF is equal to 2 ;$$

$$148 \; 480 + 32 \; 768 \times UV , if SF is equal to 3 and UV is less than 62 ;$$

$$> 2 \; 147 \; 328 , if SF equal to is 3 and UV is equal to 62 ;$$

Unspecified or Unknown, if SF is equal to 3 and UV is equal to 63.

The TXOP duration requested subfield, which may be included instead of the queue size subfield, indicates the duration, in units of 32 microseconds (us), that the sending STA determines it needs for its next TXOP for the specified TID. The TXOP duration requested subfield is set to 0 to indicate that no TXOP is requested for the specified TID in the current service period (SP). The TXOP duration requested subfield is set to a nonzero value to indicate a requested TXOP duration in the range of 32 us to 8160 us in increments of 32 us.

The HT control field may include a BSR control subfield which may contain buffer status information used for UL MU operation. The BSR control subfield may be formed from an access category index (ACI) bitmap subfield, a delta TID subfield, an ACI high subfield, a scaling factor subfield, a queue size high subfield, and a queue size all subfield of the HT control field.

The ACI bitmap subfield indicates the access categories for which buffer status is reported (e.g., B0: best effort (AC_BE), B1: background (AC_BK), B2: video (AC_VI), B3: voice (AC_VO), etc.). Each bit of the ACI bitmap subfield is set to 1 to indicate that the buffer status of the corresponding AC is included in the queue size all subfield, and set to 0 otherwise, except that if the ACI bitmap subfield is 0 and the delta TID subfield is 3, then the buffer status of all 8 TIDs is included.

The delta TID subfield, together with the values of the ACI bitmap subfield, indicate the number of TIDs for which the STA is reporting the buffer status.

The ACI high subfield indicates the ACI of the AC for which the BSR is indicated in the queue size high subfield. The ACI to AC mapping is defined as ACI value 0 mapping to AC_BE, ACI value 1 mapping to AC_BK, ACI value 2 mapping to AC_VI, and ACI value 3 mapping to AC_VO.

The scaling factor subfield indicates the unit SF, in octets, of the queue size high and queue size all subfields.

The queue size high subfield indicates the amount of buffered traffic, in units of SF octets, for the AC identified by the ACI high subfield, that is intended for the STA identified by the receiver address of the frame containing the BSR control subfield.

The queue size all subfield indicates the amount of buffered traffic, in units of SF octets, for all ACs identified by the ACI Bitmap subfield, that is intended for the STA identified by the receiver address of the frame containing the BSR control subfield.

The queue size values in the queue size high and queue size all subfields are the total sizes, rounded up to the nearest multiple of SF octets, of all MSDUs and A-MSDUs buffered at the STA (including the MSDUs or A-MSDUs contained in the same PSDU as the frame containing the BSR control subfield) in delivery queues used for MSDUs and A-MSDUs associated with AC(s) that are specified in the ACI high and ACI bitmap subfields, respectively.

A queue size value of 254 in the queue size high and queue size all subfields indicates that the amount of buffered traffic is greater than 254×SF octets. A queue size value of 255 in the queue size high and queue size all subfields indicates that the amount of buffered traffic is an unspecified or unknown size. The queue size value of QoS data frames containing fragments may remain constant even if the amount of queued traffic changes as successive fragments are transmitted.

MAC service provides peer entities with the ability to exchange MSDUs. To support this service, a local MAC uses the underlying PHY-level service to transport the MSDUs to a peer MAC entity. Such asynchronous MSDU transport is performed on a connectionless basis.

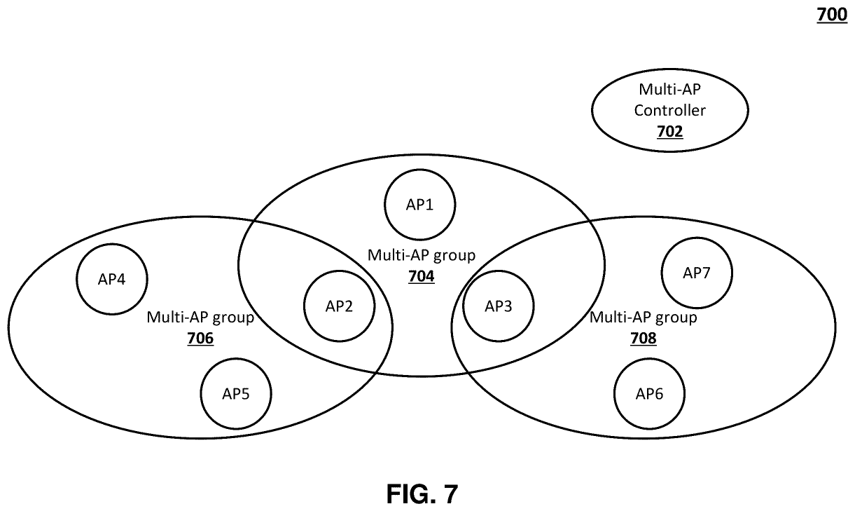

FIG. 7 illustrates an example multi-AP network 700. Example multi-AP network 700 may be a multi-AP network in accordance with the Wi-Fi Alliance standard specification for multi-AP networks. As shown in FIG. 7, multi-AP network 700 may include a multi-AP controller 702 and a plurality of multi-AP groups (or multi-AP sets) 704, 706, and 708.

Multi-AP controller 702 may be a logical entity that implements logic for controlling the APs in multi-AP network 700. Multi-AP controller 702 may receive capability information and measurements from the APs and may trigger AP control commands and operations on the APs. Multi-AP controller 702 may also provide onboarding functionality to onboard and provision APs onto multi-AP network 700.

Multi-AP groups 704, 706, and 708 may each include a plurality of APs. APs in a multi-AP group are in communication range of each other. However, the APs in a multi-AP group are not required to have the same primary channel. As used herein, the primary channel for an AP refers to a default channel that the AP monitors for management frames and/or uses to transmit beacon frames. For a STA associated with an AP, the primary channel refers to the primary channel of the AP, which is advertised through the AP's beacon frames.

In one approach, one of the APs in a multi-AP group may be designated as a master AP. The designation of the master AP may be done by multi-AP controller 702 or by the APs of the multi-AP group. The master AP of a multi-AP group may be fixed or may change over time between the APs of the multi-AP group. An AP that is not the master AP of the multi-AP group is known as a slave AP.

In one approach, APs in a multi-AP group may coordinate with each other, including coordinating transmissions within the multi-AP group. One aspect of coordination may include coordination to perform multi-AP transmissions within the multi-AP group. As used herein, a multi-AP transmission is a transmission event in which multiple APs (of a multi-AP group or a multi-AP network) transmit simultaneously over a period. The period of simultaneous AP transmission may be a continuous period.

Multi-AP group coordination may be enabled by the multi-AP controller and/or by the master AP of the multi-AP group. In one approach, the multi-AP controller and/or the master AP may control time and/or frequency sharing in a TXOP. For example, when one of the APs (e.g., the master AP) in the multi-AP group obtains a TXOP, the multi-AP controller and/or the master AP may control how time/frequency resources of the TXOP are to be shared with other APs of the multi-AP group. In an implementation, the AP of the multi-AP group that obtains a TXOP becomes the master AP of the multi-AP group. The master AP may then share a portion of its obtained TXOP (which may be the entire TXOP) with one or more other APs of the multi-AP group.

Multi-AP operation may be enabled by at least two APs that support multi-AP coordination within one or more multi-AP groups. The APs may support multi-AP transmission schemes in a multi-AP network. A master AP may coordinate with slave AP(s) to enable multi-AP coordination and to support a multi-AP transmission. Slave AP(s) may participate in a multi-AP transmission. The master AP may select the slave AP(s) which are suitable for the multi-AP transmission. Slave APs may be candidates for a multi-AP transmission before being designated by the master AP.

Multi-AP transmission schemes may include transmission schemes such as coordinated OFDMA, coordinated time division multiple access (TDMA), coordinated spatial reuse, coordinated beamforming, joint transmission or reception (JT/JR), or a combination of two or more of the aforementioned schemes.

Coordinated OFDMA and coordinated TDMA may be categorized as coordinated TXOP, in which frequency or time resources of a TXOP may be used to coordinate the interference. Coordinated spatial reuse (CSR) may provide reuse of spatial domain of neighboring BSSs by adjusting the transmit powers of coordinated APs. Coordinated beamforming (CBF) may provide dedicated null steering with spatial radiation based on channel state information (CSI) feedback from coordinated APs with the aid of multiple antennas to suppress the interference. Joint transmission or reception (JT/JR) may use distributed MIMO precoding or detection, via shared CSI, for data streams among multiple APs.

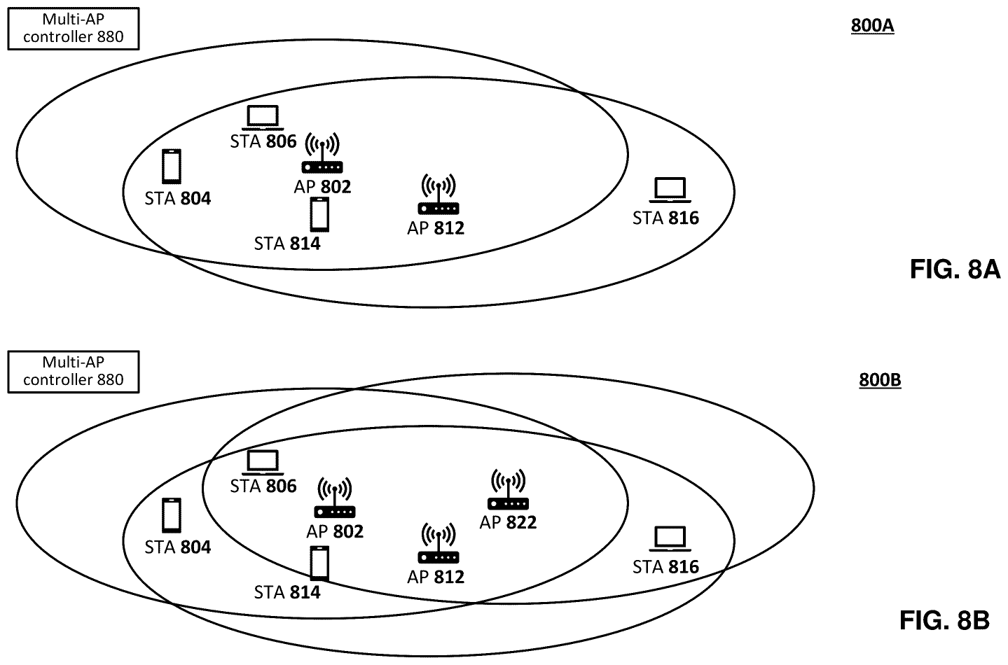

FIG. 8A illustrates another example 800A of a multi-AP network. Example multi-AP network 800A may be an embodiment of multi-AP network 700 with the number of multi-AP groups being equal to one. As shown in FIG. 8A, example multi-AP network 800A may include a multi-AP controller 880, a first BSS, and a second BSS. In an implementation, the multi-AP controller 880 may be implemented in a master AP of the first BSS or the second BSS. The first BSS may include an AP 802 and a plurality of STAs 804 and 806. STAs 804 and 806 may be associated with AP 802. The second BSS may include an AP 812 and a plurality of STAs 814 and 816. STAs 814 and 816 may be associated with AP 812. In an example, AP 802 and AP 812 may form a multi-AP group. AP 802 may be the master AP while AP 812 may be a slave AP of the multi-AP group. For example, AP 802 may obtain a TXOP making it the master AP of the multi-AP group. Alternatively, AP 802 may be designated as the master AP, manually by a human administrator (e.g., through a user interface of AP 802) or by a multi-AP controller.

FIG. 8B illustrates another example 800B of a multi-AP network. Example multi-AP network 800B may be an embodiment of multi-AP network 700 with the number of multi-AP groups being equal to one. As shown in FIG. 8B, example multi-AP network 800B may include a multi-AP controller 880, a first BSS, a second BSS, and a third BSS. In an implementation, the multi-AP controller 880 may be implemented in a master AP of the first BSS, the second BSS, or the third BSS. The first BSS may include an AP 802 and a plurality of STAs 804 and 806. STAs 804 and 806 may be associated with AP 802. The second BSS may include an AP 812 and a plurality of STAs 814 and 816. STAs 814 and 816 may be associated with AP 812. The third BSS may include an AP 822. In an example, AP 802, AP 812, and AP 822 may form a multi-AP group. AP 802 may be the master AP while AP 812 and AP 822 may be slave APs of the multi-AP group. For example, AP 802 may obtain a TXOP making it the master AP of the multi-AP group. Alternatively, AP 802 may be designated as the master AP, manually by a human administrator (e.g., through a user interface of AP 802) or by a multi-AP controller.

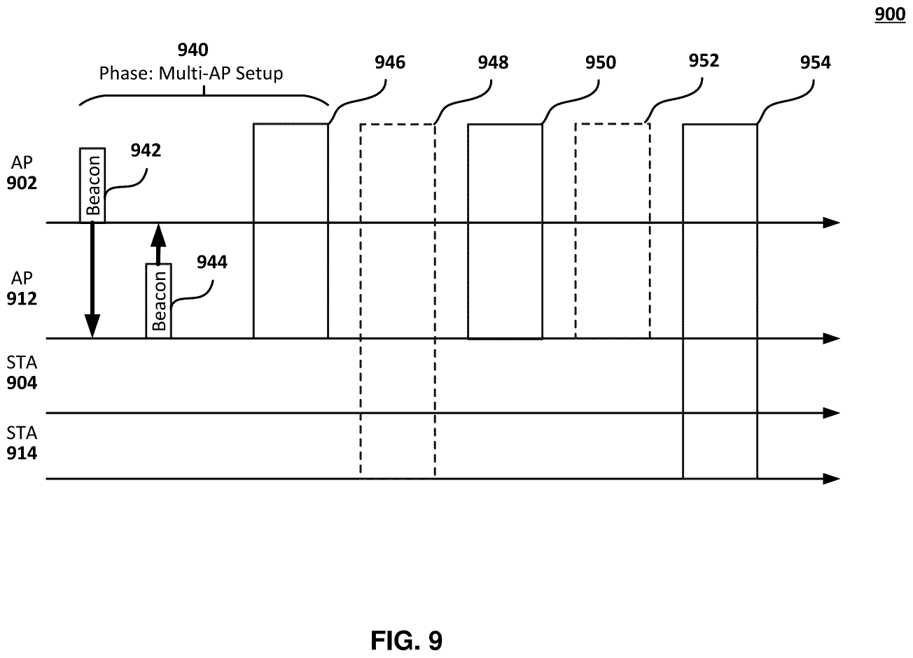

FIG. 9 illustrates an example 900 of a multi-AP operation procedure. In example 900, the multi-AP operation procedure is illustrated with respect to a multi-AP network that includes APs 902 and 912 and STAs 904 and 914. In an example, APs 902 and 912 may form a multi-AP group. AP 902 may be the master AP and AP 912 may be a slave AP of the multi-AP group. For example, AP 902 may obtain a TXOP making it the master AP of the multi-AP group. Alternatively, AP 902 may be designated as the master AP by a multi-AP controller.

As shown in FIG. 9, the multi-AP operation procedure may include a series of phases in time, each of which may contain a plurality of frame exchanges within the multi-AP network. Specifically, the multi-AP operation procedure may include a multi-AP setup phase 940, a multi-AP information exchange phase 946, an optional multi-AP sounding phase 948, a multi-AP selection phase 950, an optional multi-AP data sharing phase 952, and a multi-AP data transmission phase 954.

Multi-AP setup phase 940 may include the initialization and setup for multi-AP operation. During this phase, APs may transmit frames to notify of their availability and exchange information that may be required for establishing a multi-AP group. For example, as shown in FIG. 9, in phase 940, AP 902 may broadcast a frame 942 which may be received by AP 912. Similarly, AP 912 may broadcast a frame 944 which may be received by AP 902. Frames 942 and 944 may be beacon frames. In frames 942 and 944, APs 902 and 912 may include information regarding AP capability. In an implementation, the AP capability information may include information regarding whether the AP supports multi-AP operation.

Multi-AP information exchange phase 946 may be used to exchange information related to multi-AP network operation, including BSS information of APs and link quality information between each AP and its associated STAs, for example. The BSS information of an AP may include a BSS ID of the BSS of the AP, identifiers and/or capabilities of STAs belonging to the BSS, information regarding sounding capabilities of the STAs, buffer status information associated with the BSS of AP, MIMO configuration of AP, etc. In an implementation, multi-AP information exchange phase 946 may be part of multi-AP setup phase 940. Link quality information may include received signal strength indicator (RSSI), signal-to-noise ratio (SNR), signal-to-interference-plus-noise-ratio (SINR), channel state information (CSI), channel quality indicator (CQI).

Multi-AP sounding phase 948 may include procedures for multi-AP channel sounding, including channel estimation and feedback of channel estimates among the master AP, candidate slave AP(s), and associated STAs. Phase 948 may be optional for some multi-AP transmission schemes. For example, phase 948 may be optional for coordinated spatial reuse (CSR) as channel information is not required.

Multi-AP selection phase 950 may include procedures for soliciting, selecting, or designating slave AP(s) for a multi-AP group by a master AP. Phase 950 may include the same procedures for reselecting another candidate slave AP, when a candidate slave AP being solicited is not available during the selection.

Multi-AP data sharing phase 952 may include procedures for sharing the data frames to be transmitted to associated STAs among the master AP and designated slave AP(s) via direct connections between APs. Phase 952 may be optional for some multi-AP data transmission schemes. For example, phase 952 may be required forjoint transmission or reception (JT/JR) as data frames may be exchanged between APs before or after the multi-AP data transmission phase 954.

Multi-AP data transmission phase 954 may include exchange of data frames between the master AP, designated slave AP(s), and their associated STAs based on multi-AP transmission scheme(s) determined by the master AP. Depending on the multi-AP transmission scheme(s) to be used, phase 954 may include optional synchronization between APs within the multi-AP group before exchanging data frames between APs and STAs within the multi-AP network.

The order of phases 946 to 954 may be different than shown in FIG. 9. Further, as mentioned above, some phases may be optional and may or may not be present. For example, optional phase 948 may not be required for CSR. However, optional phase 952 may be required for JT/JR. Further, in JT, phase 952 may occur prior to phase 954, whereas, in JR, phase 952 may occur after phase 954.

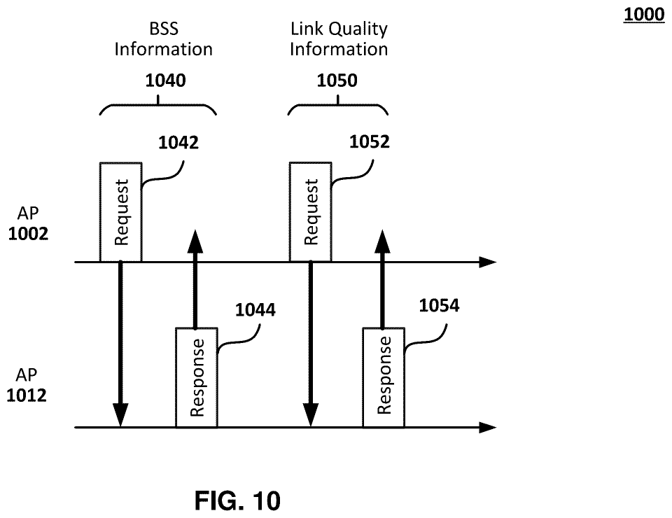

FIG. 10 illustrates an example 1000 of a multi-AP information exchange phase. Multi-AP information exchange phase 1000 may be an example of multi-AP information exchange phase 946. As shown in FIG. 10, example 1000 may include a master AP 1002 and a slave AP 1012 of a multi-AP group. In an example, AP 1002 and AP 1012 may have exchanged beacon frames in a prior phase (e.g., multi-AP setup phase 940). AP 1012 may be a candidate slave AP when phase 1000 occurs during a multi-AP setup phase or before AP 1012 is selected or designated as a slave AP in a subsequent multi-AP selection phase (e.g., multi-AP selection phase 950). By contrast, AP 1012 may be a designated slave AP when phase 1000 occurs (or repeats) after AP 1012 is selected or designated as a slave AP in a multi-AP selection phase.

As shown in FIG. 10, phase 1000 may include subphases 1040 and 1050. In an example, during subphase 1040, AP 1002 may send a frame 1042 to AP 1012 to request BSS information from AP2. Frame 1042 may be a BSS information request frame. In response, AP 1012 may send to AP 1002 a frame 1044 including the BSS information of AP 1012. Frame 1044 may be a BSS information response frame.

In an example, during subphase 1050, AP 1002 may send a further frame 1052 to AP 1012 to request link quality information from AP 1012. In response, AP 1012 may send to AP 1002 a frame 1054 including the requested link quality information. Frame 1052 may be a link quality information response frame.

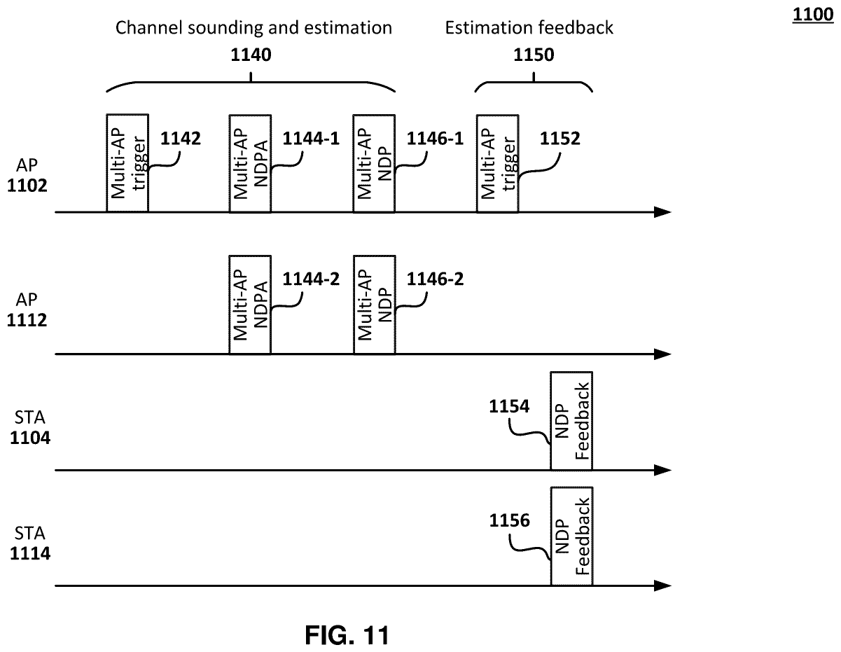

FIG. 11 illustrates an example 1100 of a multi-AP sounding phase. Multi-AP sounding phase 1100 may be an example of multi-AP sounding phase 948. As shown in FIG. 11, example 1100 may include a master AP 1102 and a slave AP 1112 of a multi-AP group. Example 1100 may further include a STA 1104 associated with AP 1102 and a STA 1114 associated with AP 1112.

As shown in FIG. 11, multi-AP sounding phase 1100 may include frame exchanges to allow AP 1102 (the master AP) to acquire channel state information (CSI) of channels in the multi-AP network. In an implementation, phase 1100 may include a first subphase 1140 and a second subphase 1150.

During the first subphase 1140, APs may initiate channel sounding and STAs may estimate channel state information (CSI) based on the sounding results of each AP and its associated STAs. For example, AP 1102 may transmit a frame 1142 to AP 1112 (the slave AP) to trigger multi-AP sounding. Frame 1142 may be a multi-AP trigger frame. Subsequently, both APs 1102 and 1112 may transmit announcement frames to their associated STAs to announce the transmission of sounding frames. For example, APs 1102 and 1112 may transmit frames 1144-1 and 1144-2 to their associated STAs 1104 and 1114, respectively. Frames 1144-1 and 1144-2 may be a multi-AP null data packet (NDP) announcement frame and may be transmitted simultaneously. Next, APs may transmit frames to their associated STAs to perform sounding for corresponding AP-to-STA channels. For example, APs 1102 and 1112 may transmit frames 1146-1 an 1145-2 to STAs 1104 and 1114 respectively. Frames 1146-1 and 1146-2 may be multi-AP NDP frames. STAs 1104 and 1114 receive frames 1146-1 and 1146-2 respectively and perform channel estimation of the channels from AP 1102 to STA 1104 and from AP 1112 to STA 1114 respectively.

During the second subphase 1150, APs may initiate the procedure for STAs to feed back the channel estimates to the APs. For example, AP 1102 may transmit a frame 1152 to trigger STAs 1104 and 1114 to transmit their channel estimates to APs 1102 and 1112. Frame 1152 may be a multi-AP trigger frame. In response, STAs 1104 and 1114 may transmit respectively frames 1154 and 1156 including feedback of channel estimates to APs 1102 and 1112. Frames 1154 and 1156 may be NDP feedback frames. The feedback of channel estimates may include NDP feedback, CSI-related information, beamforming report (BFR), or channel quality indication (CQI) report.

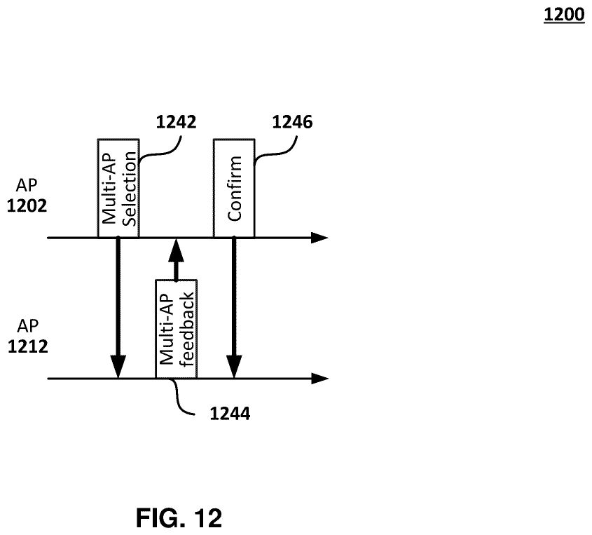

FIG. 12 illustrates an example 1200 of a multi-AP selection phase. Multi-AP selection phase 1200 may be an example of multi-AP selection phase 950. As shown in FIG. 12, example 1200 may include a master AP 1202 and a slave AP 1212 of a multi-AP group.

As shown in FIG. 12, multi-AP selection phase 1200 may include frame exchanges to allow master AP 1202 to determine whether candidate slave AP 1212 may participate in a multi-AP transmission. For example, AP 1202 may transmit a frame 1242 including information regarding selection for a multi-AP transmission to AP 1212. In an example, frame 1242 may be a control frame, e.g., a trigger frame. For example, frame 1242 is a multi-AP trigger frame. In another example, frame 1242 may be an action frame, e.g., a public action frame. For example, frame 1242 is a multi-AP selection frame. Frame 1242 may include content requesting information related to the buffer status of AP 1212. Frame 1242 may also include antenna or stream information of AP 1212. Frame 1242 may be used for synchronization between APs 1202 and 1212.

In response to frame 1242, AP 1212 may transmit a frame 1244 to AP 1202. If AP 1212 is available to participate in the multi-AP transmission, frame 1244 may include information related to buffer status and available frequency resources of AP 1212. In an example, when frame 1242 is a trigger frame, e.g., a multi-AP trigger frame, frame 1244 may be a data frame that includes a trigger-based (TB) PPDU in response to the trigger frame. In another example, when frame 1242 is a public action frame, e.g., a multi-AP selection request frame, frame 1244 may be a multi-AP selection response frame.

If AP 1212 is unavailable to transmit frame 1244 in response to frame 1242, AP 1202 may solicit another slave AP for selection for the multi-AP transmission.

Based on receiving frame 1244, AP 1202 may confirm AP 1212 as a designated AP for the multi-AP transmission by transmitting a frame 1246.

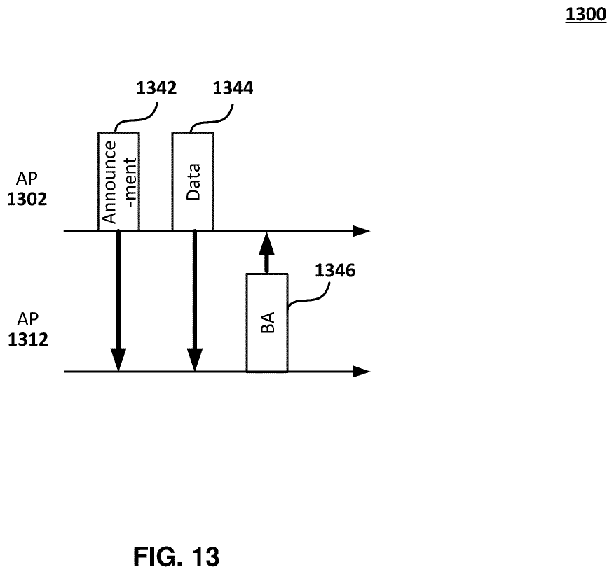

FIG. 13 illustrates an example 1300 of a multi-AP data sharing phase. Multi-AP data sharing phase 1300 may be an example of multi-AP data sharing phase 952. As shown in FIG. 13, example 1300 may include a master AP 1302 and a slave AP 1312 of a multi-AP group. As mentioned with reference to FIG. 9 above, phase 1300 may be optional for some multi-AP transmission schemes.

As shown in FIG. 13, multi-AP data sharing phase 1300 may include frame exchanges to allow master AP 1302 to share data frames with slave AP 1312 which is designated for a multi-AP transmission. The multi-AP transmission scheme may be joint transmission or reception (JT/JR), for example. Master AP 1302 may initiate the procedure by transmitting an announcement frame 1342 to notify AP 1312 of upcoming data sharing. Frame 1342 may include information related to AP 1312, for example, an identifier of AP 1312. Frame 1342 may be a broadcast frame, a management frame, or a trigger frame. Subsequently, AP 1302 may transmit a data frame 1344 to AP 1312. Data frame 1344 may correspond to a data frame transmitted or to be transmitted during the multi-AP transmission. Frame 1344 may include information related to a resource unit (RU) for transmitting an acknowledgment frame by AP 1312. AP 132 may transmit a BlockAck (BA) frame 1346 to AP 1302 using the RU indicated in frame 1344 to confirm successful reception of data frame 1344.

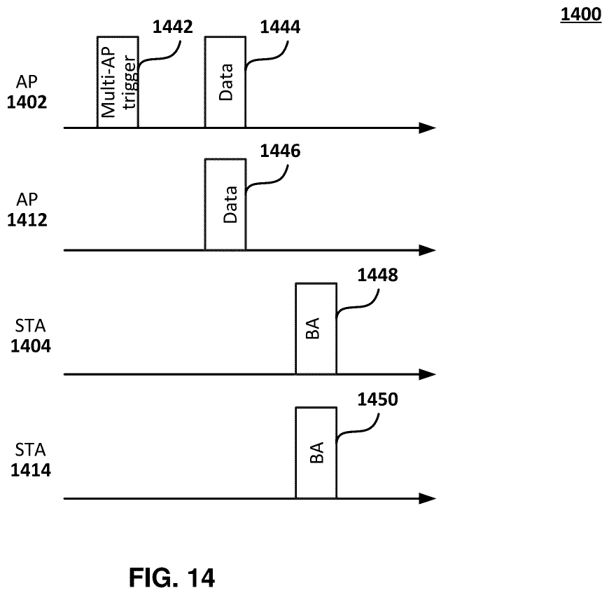

FIG. 14 illustrates an example 1400 of a multi-AP data transmission phase. Multi-AP data transmission phase 1400 may be an example of multi-AP data transmission phase 954. As shown in FIG. 14, example 1400 may include a master AP 1402 and a slave AP 1412 of a multi-AP group. Example 1400 may further include a STA 1404 associated with AP 1402, and a STA 1414 associated with AP 1412.

As shown in FIG. 14, multi-AP data transmission phase 1400 may include frame exchanges to enable master AP 1402 to coordinate with designated slave AP 1412 to perform specific multi-AP transmission schemes with their associated STAs. For example, master AP 1402 and slave AP 1412 may perform multi-AP transmission schemes with STAs 1404 and 1414 respectively. The multi-AP transmission schemes may include coordinated OFDMA, coordinated time division multiple access (TDMA), coordinated spatial reuse, coordinated beamforming, joint transmission or reception (JT/JR), or a combination of two or more of the aforementioned schemes.

As shown in FIG. 14, master AP may begin phase 1400 by transmitting a frame 1442 to AP 1412. Frame 1442 may include information related to AP 1412 (e.g., an identifier of AP 1412), synchronization information, information related to a specific multi-AP transmission scheme to be used, and/or information related to an RU for use by AP 1412 to acknowledge frame 1442. Frame 1442 may be a control frame. For example, frame 1442 may be a multi-AP trigger frame.

Slave AP 1412 may receive frame 1442 and may use the synchronization information to synchronize with master AP 1402. Subsequently, APs 1402 and 1412 may perform data transmission to their associated STAs 1404 and 1414 respectively. Specifically, AP 1402 may transmit a data frame 1444 to its associated STA 1404, and AP 1412 may transmit a data frame 1446 to its associated STA 1414. Depending on the multi-AP transmission scheme being used, frames 1444 and 1446 may also be transmitted by APs 1402 and 1412 respectively to STAs in different BSSs. For example, when the multi-AP transmission scheme is JT/JR, AP 1402 may also transmit frame 1444 to STA 1414 associated with slave AP 1412, and AP 1412 may also transmit frame 1446 to STA 1404 associated with AP 1402. The resources for transmitting and receiving frames 1444 and 1446 may depend on the specific multi-AP transmission scheme adopted.

STAs 1404 and 1414 may acknowledge frames 1444 and 1446 respectively. For example, STA 1404 may transmit a frame 1448 to AP 1402, and STA 1414 may transmit a frame 1450 to AP 1402. Frames 1448 and 1450 may be BA frames. When the multi-AP transmission scheme used requires so, STAs 1404 and 1414 may also transmit frames 1448 and 1450 to APs in different BSSs. For example, when the multi-AP transmission scheme is JT/JR, STA 1404 may also transmit frame 1448 to AP 1412, and STA 1414 may also transmit frame 1450 to AP 1402. The resources for transmitting and receiving frames 1448 and 1450 may depend on the specific multi-AP transmission scheme adopted.

As previously mentioned, a multi-AP network may carry out a multi-AP operation based on a specific multi-AP transmission scheme. During the multi-AP setup phase, a slave AP may inform the master AP of capability information related to the slave AP, including the capabilities of supporting one or more multi-AP transmission schemes. During the multi-AP information exchange frame, the slave AP may inform the master AP of BSS information of the BSS of the slave AP and of link quality information for STAs associated with the slave AP. The master AP may receive information related to all available slave APs. The information related to slave APs may include capability information, BSS information, and link quality information. Based on the information provided by available slave APs, the master AP may determine during a multi-AP selection phase the slave APs to be designated for a multi-AP transmission and a specific multi-AP transmission scheme to be used during the multi-AP transmission.

Multi-AP transmission may have various advantages and disadvantages when using different transmission schemes. Each multi-AP transmission scheme may have suitable use cases and specific requirements.

Different multi-AP transmission schemes may be suitable for different use cases in terms of privacy protection, including whether transmitted data may be shared with other BSSs in the multi-AP network. For example, some multi-AP transmission schemes, such as CSR, C-TDMA, C-FDMA, and CBF, enable a master AP to coordinate slave APs by sharing control information among APs, without requiring the sharing of user data among APs. The control information may include BSS information of APs, link quality information of channels between each AP and its associated STAs, and information related to resources to be used to achieve multiplexing in power, time, frequency, or special domains for multi-AP transmission. The control information exchanged among a master AP and slave APs may be used for interference avoidance or nulling to avoid or null co-channel interference introduced to neighboring BSSs in a multi-AP network. Interference avoidance or interference nulling require that data transmissions between an AP and STAs are only within the same BSS. In other words, each AP transmits or receives data frames to or from its associated STAs, while each STA receives or transmits data frames to or from its associating AP. By contrast, other multi-AP transmission schemes may enable a master AP to coordinate slave APs by sharing both control information and user data among APs in a multi-AP group. Control information may include BSS information related of APs and link quality information of channels between each AP and its associated STAs. By having user data exchanged over backhaul, master AP and slave APs may perform data transmission jointly based on control signals to achieve diversity in spatial domain per distributed MIMO principle, for example, JT for downlink or JR for uplink. It requires that data transmissions between AP and STAs are not only within the same BSS, but also cross different BSSs. In other words, each AP transmits or receives the data frames to or from its associated STAs and the STAs associated with other APs participating in multi-AP transmission, while each STA receives or transmits data frames to or from multiple APs.

Different multi-AP transmission schemes may be suitable for different use cases in terms of signal reception levels at STAs or APs within a multi-AP network. For example, CBF and JT/JR require that each STA involved in a multi-AP transmission be located within a common area of signal coverage of the APs involved in the multi-AP transmission. Generally, CBF may be suitable when a receiving STA suffers from potential interference from other APs in the multi-AP group. By using channel related information such as CSI, CQI, or compressed BF feedback exchanged among APs, an AP may pre-code a signal to be transmitted to form a beam that increases power toward a target STA while reducing the power that interferes with a STA associated with a neighboring AP. Use cases of JT/JR may require a sufficient received signal power at receiving STAs for JT and a sufficient received signal power at receiving APs for JR. By contrast, CSR may perform multi-AP transmission in an interference coordination manner. The received signal power at a STA associated with an AP transmitting data may be required to be much higher than the received interference power.

Different multi-AP transmission schemes may require different synchronization levels and may operate with or without a backhaul between a master AP and slave APs in a multi-AP group. For example, CSR may require PPDU-level synchronization, whereas CBF may require symbol-level synchronization. On the other hand, JT/JR may require tight time/frequency/phase-level synchronization as well as backhaul for data sharing between APs in the multi-AP group.

Different multi-AP transmission schemes may have different complexity levels with regard to coordination between a master AP and slave APs in a multi-AP group. For example, JT/JR may require very high complexity due to both CSI and user data being shared between APs. CBF may require medium complexity due to the sharing of CSI. C-FDMA and C-TDMA may require medium or relatively low complexity due to the CSI and time/frequency resources to be shared between APs. CSR may require low complexity as the amount of information related to spatial reuse and traffic that needs to be exchanged between APs may be low.

Existing procedures as illustrated in FIG. 9 adopt a static multi-AP operation including a static multi-AP transmission scheme for a multi-AP network. However, a multi-AP network may be dynamic due to various reasons. For example, a STA may join or leave the multi-AP network, a STA may switch to a power save mode, or an AP or a STA may change its location. Such changes may lead to changes in the conditions underlying the selection of the multi-AP transmission scheme and may cause certain requirements (e.g., synchronization, backhaul, coordination, etc.) for the multi-AP transmission scheme to be lost. This results in an inferior quality of transmissions in the multi-AP network.

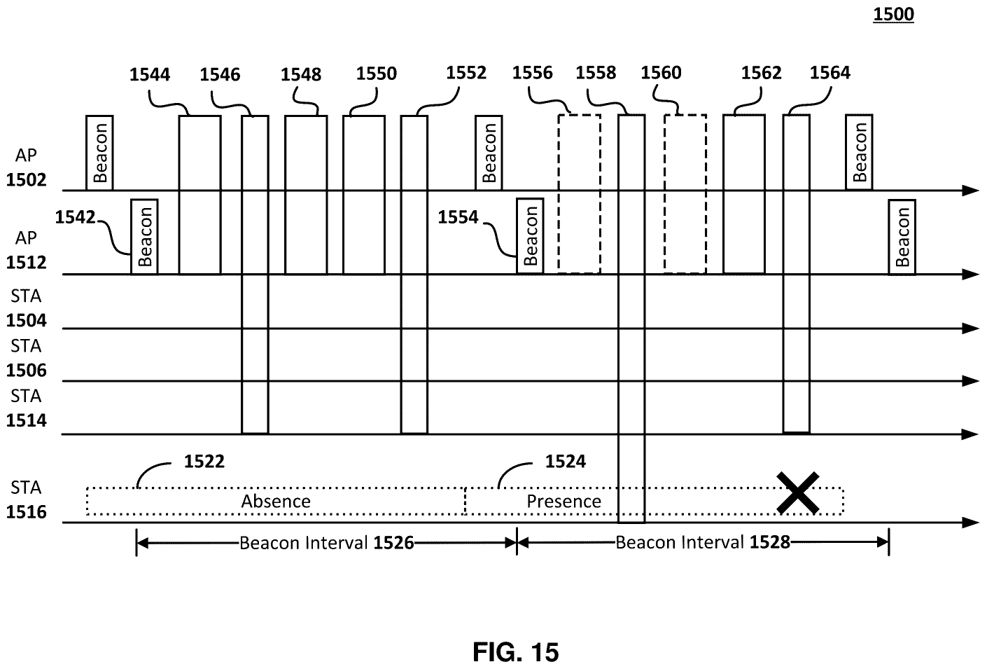

FIG. 15 illustrate an example 1500 of a problem that may arise in multi-AP operation using the existing procedure illustrated in FIG. 9. Example 1500 includes a multi-AP network including a first BSS and a second BSS. The first BSS may include an AP 1502 and a plurality of STAs 1504 and 1506. STAs 1504 and 1506 may be associated with AP 1502. The second BSS may include an AP 1512 and a plurality of STAs 1514 and 1516. STAs 1514 and 1516 may be associated with AP 1512. In an example, AP 1502 and AP 1512 may form a multi-AP group. AP 1502 may be the master AP and AP 1512 may be a slave AP of the multi-AP group. For example, AP 1502 may obtain a TXOP making it the master AP of the multi-AP group. Alternatively, AP 1502 may be designated as the master AP by a multi-AP controller.

In an example, as shown in FIG. 15, the status of STA 1516 may change over time. For example, STA 1516 may be absent during a first period 1522 and may be present during a second period 1524. In an example, STA 1504, 1506, 1514 are located in an area within signal coverage of both APs 1502 and 1512, while STA 1516 is located outside the signal coverage of AP 1502 but within the signal coverage of AP 1512. In an example, example 1500 may span a plurality of beacon intervals 1526 and 1528.

As shown in FIG. 15, example 1500 may begin with a multi-AP setup phase which may start at the beginning of beacon interval 1526 during the first period 1522 in the absence of STA 1516. Master AP 1502 may receive a frame 1542 that may include information related to the capabilities of supporting multi-AP transmission schemes for AP 1512. The multi-AP transmission schemes may include C-FDMA, C-TDMA, CSR, CBF, and JT/JR.

Subsequently, APs 1502 and 1512 may complete a multi-AP information exchange phase 1544. An example of frame exchanges during phase 1544 is described above in example 1000 of FIG. 10. Next, APs 1502 and 1512 may perform a multi-AP sounding phase 1546 with available STAs 1504, 1506, and 1514. An example of frame exchanges during phase 1544 is described above in example 1100 of FIG. 11.

In multi-AP selection phase 1548, master AP 1502 designates slave AP 1512 for a multi-AP transmission and determines the specific multi-AP transmission scheme based on the capabilities of AP 1512 for supporting multi-AP transmission schemes. As STA 1516 is absent at the time of multi-AP selection phase 1540, AP 1502 designates AP 1512 for the multi-AP transmission without considering STA 1516. An example of frame exchanges during phase 1548 is described above in example 1200 of FIG. 12. In an implementation, when AP 1512 has capabilities to support two or more multi-AP transmission schemes, e.g., CSR and JT, master AP 1502 may select one of the supported schemes, e.g., JT, based on available information. In an example, master AP 1502 may adopt JT as the multi-AP transmission scheme. As such, APs 1502 and 1512 may perform a multi-AP data sharing phase 1550 as required by JT. An example of frame exchanges during phase 1550 is described above in example 1300 of FIG. 13. Upon completion of phase 1550, APs 1502 and 1512 may perform a multi-AP data transmission phase 1552 using JT. An example of frame exchanges during phase 1552 is described above in example 1400 of FIG. 14. It is noted, as shown in FIG. 15, that phase 1552 does not include a frame exchange related to STA 1516 as STA 1516 is absent during first period 1522.

Subsequently, APs 1502 and 1512 may again exchange beacon frames. A beacon interval 1528 starts at the time of transmission by AP 1512 of a beacon frame 1554. In an example, STA 1516 becomes present in the multi-AP network before the start of beacon interval 1528. As mentioned above, AP 1512 may support two or more multi-AP transmission schemes, e.g., CSR and JT. In an example, as AP 1512 already participated in multi-AP data transmission phase 1552 in first period 1522, multi-AP information exchange phase 1556 may be optional in period 1524.

In contrast to multi-AP sounding phase 1546, multi-AP sounding phase 1558 in second period 1524 includes STA 1516 allowing master AP 1502 to obtain CSI for the channels between AP 1512 and STA 1416. In an example, AP 1512 continues to serve as a designated slave AP, in which case multi-AP selection phase 1560 may be optional. As such, AP 1502 may use the same information obtained during the first beacon interval 1526 and may continue to adopt the same multi-AP transmission scheme used in multi-AP data transmission phase 1552 (for example, JT) for multi-AP data transmission phase 1564. In an example, a multi-AP data sharing phase 1562 may take place before multi-AP data transmission phase 1564. An example of frame exchanges during phase 1564 is described above in example 1400 of FIG. 14. It is noted, as shown in FIG. 15, that phase 1564 does not include a frame exchange related to STA 1516, even if STA 1516 is present during first period 1522.

However, as mentioned above, STA 1516, which became present in second period 1524, is outside the signal coverage of AP 1502. STA 1516 may thus fail to receive the signal from AP 1502 during the JT transmission performed during phase 1564. As a result, the expected performance enhancement due to multi-AP transmission is not realized for STA 1516.

The problem illustrated in FIG. 15 occurs due to shortcomings in the existing procedure for multi-AP operation. In a first aspect, the existing procedure relies on the master AP determining a multi-AP transmission scheme for a multi-AP transmission without consideration of whether the selected scheme can be adequately performed in the BSS of a slave AP. In another aspect, as illustrated in example 1500, the existing procedure may use static and/or stale information in selecting the multi-AP transmission scheme. However, the dynamic nature of a multi-AP network may lead to a selected multi-AP transmission scheme becoming sub-optimal or inadequate. As such, existing procedures for establishing and maintaining multi-AP transmissions may result in situations of unsuccessful communication between a participating AP of the multi-AP transmission and one or more STAs. Such situations not only cause inefficient coordination and resource waste for the multi-AP transmission but also may cause a latency increase, throughput decrease, and QoS performance decrease for the multi-AP network.

Embodiments of the present disclosure, as further described below, provide enhanced procedures which may be used to setup, coordinate, perform, and/or update multi-AP transmissions using specific multi-AP transmission schemes. The proposed procedures mitigate the above-discussed situations of unsuccessful communications. In one aspect, the proposed procedures reduce such situations, particularly for dynamic multi-AP networks. As such, coordination efficiency, resource utilization, latency reduction and QoS performance may be improved within the multi-AP network.

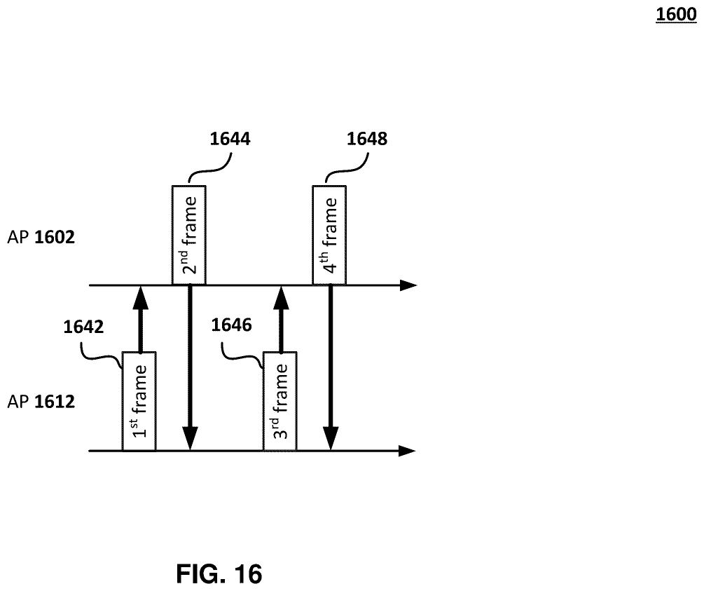

FIG. 16 illustrates an example 1600 of frame exchanges including preferred multi-AP transmission scheme information in a multi-AP network. Example 1600 is provided for the purpose of illustration only and is not limiting. Like example 1500 described above, example 1600 includes a plurality of APs, AP 1602 and AP 1612. In an example, APs 1602 and 1612 form a multi-AP group. AP 1602 may be the master AP while AP 1612 may be a slave AP of the multi-AP group. For example, AP 1602 may obtain a TXOP making it the master AP of the multi-AP group. Alternatively, AP 1602 may be designated as the master AP by a multi-AP controller. AP 1602 and AP 1612 may exchange frames to set up a multi-AP transmission and form a coordinated AP set. The coordinated AP set corresponds to the set of APs that participate in the multi-AP transmission. APs 1602, 1622, and 1622 within the coordinated AP set may exchange frames to coordinate, perform, and/or update the multi-AP transmission. The coordinated AP set may be part of the multi-AP group.

In an example, each of AP 1602 and AP 1612 may have one or more associated STAs (not shown in FIG. 16). For the purpose of illustration, it is assumed that APs 1602 and 1612 may exchange a plurality of frames, for example, a first frame 1642, a second frame 1644, a third frame 1646, and a fourth frame 1648, during a multi-AP operation procedure. It is further assumed, for the purpose of illustration, that the order of frames shown in FIG. 16 may or may not relate to the order of the frames being transmitted by APs 1602 and 1612. It is also assumed that the multi-AP network may change its status dynamically during a plurality of consecutive periods. It is additionally assumed that two or more multi-AP transmission schemes are supported by each of APs 1602 and 1612 in the multi-AP group. The multi-AP transmission schemes may include transmission schemes such as coordinated OFDMA, coordinated TDMA, coordinated spatial reuse (CSR), coordinated beamforming (CBF), joint transmission or reception (JT/JR), or a combination of two or more of the aforementioned schemes. In an embodiment, prior to the beginning of example 1600 (not shown in FIG. 16), AP 1602 and AP 1612 may exchange frames to exchange capability information. In an example, AP 1602 may transmit to AP 1612 a first indication of support by AP 1602 of two or more multi-AP transmission schemes. In another example, AP 1612 may transmit to AP 1602 a second indication of support by AP 1612 of two or more multi-AP transmission schemes. In an embodiment, AP 1602 may transmit to AP 1612 a third indication of support by AP 1602 of a multi-AP transmission scheme selection capability. In another embodiment, AP 1612 may transmit to AP 1602 a fourth indication of support by AP 1612 of the multi-AP transmission scheme selection capability. It is assumed in example 1600 that both AP 1602 and AP 1612 support the multi-AP transmission scheme selection capability. In an example, supporting multi-AP transmission scheme selection capability allows AP 1612 to transmit frames (such as frames 1642, 1646) to share information of multi-AP transmission scheme with AP 1602. In an example, supporting multi-AP transmission scheme selection capability allows AP 1602 to receive and process frames (such as frames 1642, 1646) to determine the selection of multi-AP transmission scheme. In an example, supporting multi-AP transmission scheme selection capability allows AP 1602 to transmit frames (such as frames 1644, 1648) to announce the designation of multi-AP transmission scheme.

In an embodiment, slave AP 1612 transmits first frame 1642 to master AP 1602. The AP 1612 may be a candidate slave AP that wishes to participate in a multi-AP transmission. Frame 1642 comprises an indication of a first multi-AP transmission scheme for use in a coordinated AP set comprising APs 1602 and 1612. The coordinated AP set corresponds to the set of APs that participate in the multi-AP transmission. The first multi-AP transmission scheme corresponds to a preferred multi-AP transmission scheme for AP 1612 for use in the coordinated AP set. The preferred multi-AP transmission schemes for AP 1612 may be determined by AP 1612 from among one or more supported multi-AP transmission schemes, based on information related to AP 1612. The information related to the AP 1612 may include BSS information of AP 1612, link quality information of AP 1612, and levels of synchronization and complexity supported by AP 1612. BSS information of AP 1612 may include a BSS ID of the BSS of the AP 1612, identifiers and/or capabilities of STAs belonging to the BSS of the AP 1612, information regarding sounding capabilities of the STAs associated with AP 1612, buffer status information associated with the BSS of AP 1612, MIMO configuration of AP 1612, etc. Link quality information may include received signal strength indicator (RSSI), signal-to-noise ratio (SNR), signal-to-interference-plus-noise ratio (SINR), channel state information (CSI), and channel quality indicator (CQI). Frame 1642 may be a management frame or a data frame. The coordinated AP set may be part of the multi-AP group comprising AP 1602 and AP 1612.

In an embodiment, receiving of the first frame 1642 occurs during a setup phase of the coordinated AP set. In an embodiment, receiving of the first frame 1642 occurs after a setup phase of the coordinated AP set.

In an embodiment, the indication of the first multi-AP transmission scheme includes no preference for a multi-AP transmission scheme.

In an embodiment, AP 1602 transmits a second frame 1644 announcing a second multi-AP transmission scheme to be used by the coordinated AP set. The second multi-AP transmission scheme may be determined based on the first multi-AP transmission scheme indicated in frame 1642. Frame 1644 may be a management frame. In an example, the second multi-AP transmission scheme indicated in frame 1644 is the same as or different than the first multi-AP transmission scheme indicated in frame 1642.

In an implementation, AP 1602 determines the second multi-AP transmission scheme to improve the performance of the multi-AP network by analyzing link quality information available at APs 1602 and 1612. For example, the link quality information may be measured by STAs and fed back or reported to APs. Link quality information may include received signal strength indicator (RSSI), signal-to-noise ratio (SNR), signal-to-interference-plus-noise ratio (SINR), channel state information (CSI), and channel quality indicator (CQI). For example, if the link quality information at AP 1612 indicates a significantly lower link quality between AP 1612 and its associated STAs than between AP 1602 and its associated STAs, AP 1602 may prioritize multi-AP transmission schemes (e.g., CSR or CBF) that may boost signal-to-interference ratio at the associated STAs of AP 1612.

As discussed above, the dynamic status of the multi-AP network may impact the use cases and/or the conditions for using multi-AP transmission schemes over time. In an embodiment, the procedure including the exchange of first and second frames 1642 and 1644 may be used to establish a subsequent multi-AP transmission using a multi-AP transmission scheme determined based on a preferred multi-AP transmission scheme of slave AP 1612. Further proposed procedures with frame exchanges may be used for coordinating and/or updating an existing multi-AP transmission with the intention to change the specific multi-AP transmission scheme.

In an example, slave AP 1612 may transmit a third frame 1646 to master AP 1602. Frame 1646 may include an indication of a third multi-AP transmission scheme for the coordinated AP set comprising APs 1602 and 1612. Frame 1646 may be a management frame or a data frame. The third multi-AP transmission scheme may correspond to an update of the first multi-AP transmission scheme for AP 1612. The update of the first multi-AP transmission scheme for AP 1612 may be determined based on an update of information related to AP 1612. The update of information related to AP 1612 may include an update of BSS information of AP 1612, an update of link quality information of AP 1612, and/or an update of a level of synchronization or complexity supported by AP 1612. In an example, the third multi-AP transmission scheme is different from the first multi-AP transmission scheme indicated in frame 1642 or the second multi-AP transmission scheme indicated in 1644.

In response to frame 1646, AP 1602 may transmit a fourth frame 1648 announcing a fourth multi-AP transmission scheme to be used for the coordinated AP set. The fourth multi-AP transmission scheme may be determined based on the second multi-AP transmission scheme indicated in frame 1644 and/or the third multi-AP transmission scheme indicated in frame 1646. Frame 1648 may be a management frame.

In an implementation, AP 1602 determines the fourth multi-AP transmission scheme to improve the performance of the multi-AP network by analyzing link quality information available at APs 1602 and 1612. For example, the link quality information may be measured by STAs and fed back or reported to APs. Link quality information may include received signal strength indicator (RSSI), signal-to-noise ratio (SNR), signal-to-interference-plus-noise ratio (SINR), channel state information (CSI), and channel quality indicator (CQI). For example, if the link quality information at AP 1612 indicates a significantly lower link quality between AP 1612 and its associated STAs than between AP 1602 and its associated STAs, AP 1602 may prioritize multi-AP transmission schemes (e.g., CSR or CBF) that may boost signal-to-interference ratio at the associated STAs of AP 1612.

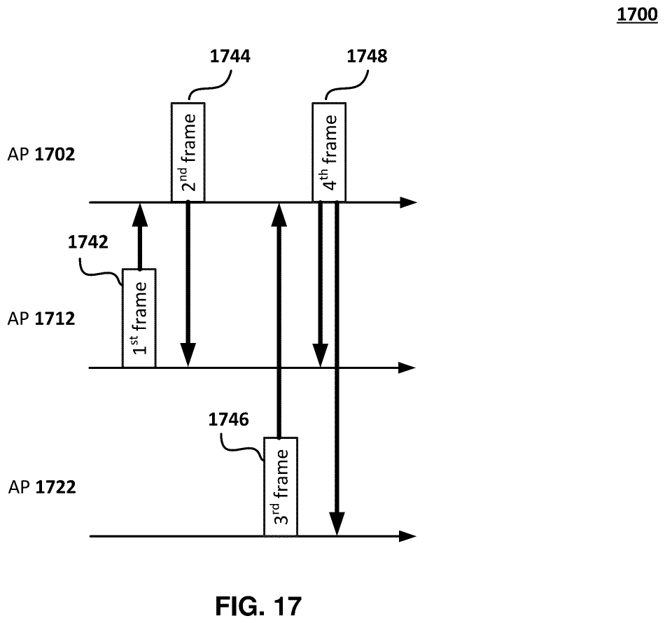

FIG. 17 illustrates an example 1700 of frame exchanges including preferred multi-AP transmission scheme information in a multi-AP network. Example 1700 is provided for the purpose of illustration only and is not limiting. Like example 1600 described above, example 1700 includes a plurality of APs, AP 1702, AP 1712, and AP 1722. In an example, APs 1702, 1712, and 1722 form a multi-AP group. AP 1702 may be the master AP while APs 1712 and 1722 may be slave APs of the multi-AP group. For example, AP 1702 may obtain a TXOP making it the master AP of the multi-AP group. Alternatively, AP 1702 may be designated as the master AP by a multi-AP controller. APs 1702, 1722, and 1722 may exchange frames to set up a multi-AP transmission and form a coordinated AP set. APs 1702, 1722, and 1722 within the coordinated AP set may exchange frames to coordinate, perform, and/or update multi-AP transmissions. The coordinated AP set may be part of the multi-AP group.

In an example, each of APs 1702, 1712, and 1722 in example 1700 may have one or more associated STAs (not shown in FIG. 17). For the purpose of illustration, it is assumed that APs 1702, 1712, and 1722 may exchange a plurality of frames, for example, a first frame 1742, a second frame 1744, a third frame 1746, and a fourth frame 1748, during a multi-AP operation procedure. It is further assumed, for the purpose of illustration, that the order of frames shown in FIG. 17 may or may not relate to the order of the frames being transmitted by APs 1702, 1712, and 1722. It is also assumed that the multi-AP network may change its status dynamically during a plurality of consecutive periods. It is additionally assumed that two or more multi-AP transmission schemes are supported by each of APs 1702, 1712, and 1722 in the multi-AP group. The multi-AP transmission schemes may include transmission schemes such as coordinated OFDMA, coordinated TDMA, coordinated spatial reuse (CSR), coordinated beamforming (CBF), joint transmission or reception (JT/JR), or a combination of two or more of the aforementioned schemes. In an embodiment, prior to the beginning of example 1700 (not shown in FIG. 17), APs 1702, 1712, and 1722 may exchange frames to exchange capability information. In an example, AP 1702 may transmit to APs 1712 and 1722 a first indication of support by AP 1702 of two or more multi-AP transmission schemes. In an example, AP 1712 may transmit to APs 1702 and 1722 a second indication of support by AP 1712 of two or more multi-AP transmission schemes. In an example, AP 1722 may transmit to APs 1702 and 1712 a third indication of support by AP 1722 of two or more multi-AP transmission schemes. In an embodiment, AP 1702 may transmit to APs 1712 and 1722 a fourth indication of support by AP 1702 of a multi-AP transmission scheme selection capability. In embodiment, AP 1712 may transmit to APs 1702 and 1722 a fifth indication of support by AP 1712 of the multi-AP transmission scheme selection capability. In another embodiment, AP 1722 may transmit to APs 1702 and 1712 a sixth indication of support by AP 1722 of the multi-AP transmission scheme selection capability. It is assumed in example 1700 that all APs 1702, 1712, and 1722 support the multi-AP transmission scheme selection capability.

In an embodiment, a slave AP 1712 transmits first frame 1742 to master AP 1702. The AP 1712 may be a candidate slave AP that wishes to participate in a multi-AP transmission. Frame 1742 comprises an indication of a first multi-AP transmission scheme for used in a coordinated AP set comprising APs 1702 and 1712. The coordinated AP set corresponds to the set of APs that participate in the multi-AP transmission. The first multi-AP transmission scheme corresponds to a preferred multi-AP transmission scheme for AP 1712 for used in the coordinated AP set. The preferred multi-AP transmission schemes for AP 1712 may be determined by AP 1712 from among one or more supported multi-AP transmission schemes, based on information related to AP 1712. The information related to AP 1612 may include BSS information of AP 1712, link quality information of AP 1712, and levels of synchronization and complexity supported by AP 1712. BSS information of AP 1712 may include a BSS ID of the BSS of the AP 1712, identifiers and/or capabilities of STAs belonging to the BSS of the AP 1712, information regarding sounding capabilities of the STAs associated with AP 1712, buffer status information associated with the BSS of AP 1712, MIMO configuration of AP 1712, etc. Link quality information may include received signal strength indicator (RSSI), signal-to-noise ratio (SNR), signal-to-interference-plus-noise ratio (SINR), channel state information (CSI), and channel quality indicator (CQI). Frame 1742 may be a management frame or a data frame. The coordinated AP set may be part of the multi-AP group comprising AP 1702, 1712, and AP 1722.

In an embodiment, receiving of the first frame 1742 occurs during a setup phase of the coordinated AP set. In an embodiment, receiving of the first frame 1742 occurs after a setup phase of the coordinated AP set.

In an embodiment, the indication of the first multi-AP transmission scheme includes no preference for a multi-AP transmission scheme.

In an embodiment, AP 1702 transmits a second frame 1744 announcing a second multi-AP transmission scheme to be used by the coordinated AP set. The second multi-AP transmission scheme may be determined based on the first multi-AP transmission scheme indicated in frame 1742. Frame 1744 may be a management frame. In an example, the second multi-AP transmission scheme indicated in frame 1744 is the same as or different than the first multi-AP transmission scheme indicated in frame 1742.

In an implementation, AP 1702 determines the second multi-AP transmission scheme to improve the performance of the multi-AP network by analyzing link quality information available at APs 1702 and 1712. For example, the link quality information may be measured by STAs and fed back or reported to APs. Link quality information may include received signal strength indicator (RSSI), signal-to-noise ratio (SNR), signal-to-interference-plus-noise ratio (SINR), channel state information (CSI), and channel quality indicator (CQI). For example, if the link quality information at AP 1712 indicates a significantly lower link quality between AP 1712 and its associated STAs than between AP 1702 and its associated STAs, AP 1702 may prioritize multi-AP transmission schemes (e.g., CSR or CBF) that may boost signal-to-interference ratio at the associated STAs of AP 1712.

As discussed above, the dynamic status of the multi-AP network may impact the use cases and/or the conditions for using multi-AP transmission schemes over time. In an embodiment, the procedure including the exchange of first and second frames 1742 and 1744 may be used to establish a subsequent multi-AP transmission using a multi-AP transmission scheme determined based on a preferred multi-AP transmission scheme of slave AP 1712. Further proposed procedures with frame exchanges may be used for coordinating and updating an existing multi-AP transmission with the intention to change the specific multi-AP transmission scheme.

In an embodiment, slave AP 1722 transmits a third frame 1746 to master AP 1702. In an example, AP 1722 is another slave AP designated to participate in the multi-AP transmission. Frame 1746 includes an indication of a third multi-AP transmission scheme for use in the coordinated AP set comprising APs 1702, 1712, and 1722. The third multi-AP transmission scheme may correspond to a preferred multi-AP transmission scheme for AP 1722. Frame 1746 may be a management frame or a data frame.

In an embodiment, AP 1702 transmits a fourth frame 1748 announcing a fourth multi-AP transmission scheme to be used for the coordinated AP set determined based on the second multi-AP transmission scheme indicated in frame 1744 and/or the third multi-AP transmission scheme indicated in frame 1746. The fourth multi-AP transmission scheme indicated in frame 1748 may be the same as the first multi-AP transmission scheme indicated in frame 1742 or the third multi-AP transmission scheme indicated in frame 1746, or different than the first multi-AP transmission scheme indicated in frame 1742, and the third multi-AP transmission scheme indicated in frame 1746.

In an example, the order of frames 1744 and frame 1746 may be different than shown in FIG. 17. In an embodiment, when frame 1746 is received by AP 1702 before the transmission of frame 1744 by AP 1702, AP 1702 may transmit frame 1748 only. The fourth multi-AP transmission scheme indicated in frame 1748 may be the same as the first multi-AP transmission scheme indicated in frame 1742 or the third multi-AP transmission scheme indicated in frame 1746, or different than the first multi-AP transmission scheme indicated in frame 1742 and the third multi-AP transmission scheme indicated in frame 1746.

In an implementation, AP 1702 determines the fourth multi-AP transmission scheme to improve the performance of the multi-AP network by analyzing link quality information available at APs 1702 and 1712. For example, the link quality information may be measured by STAs and fed back or reported to APs. Link quality information may include received signal strength indicator (RSSI), signal-to-noise ratio (SNR), signal-to-interference-plus-noise ratio (SINR), channel state information (CSI), and channel quality indicator (CQI). For example, if the link quality information at AP 1722 indicates a significantly lower link quality between AP 1722 and its associated STAs than between AP 1702 and its associated STAs, AP 1702 may prioritize multi-AP transmission schemes (e.g., CSR or CBF) that may boost signal-to-interference ratio at the associated STAs of AP 1722.

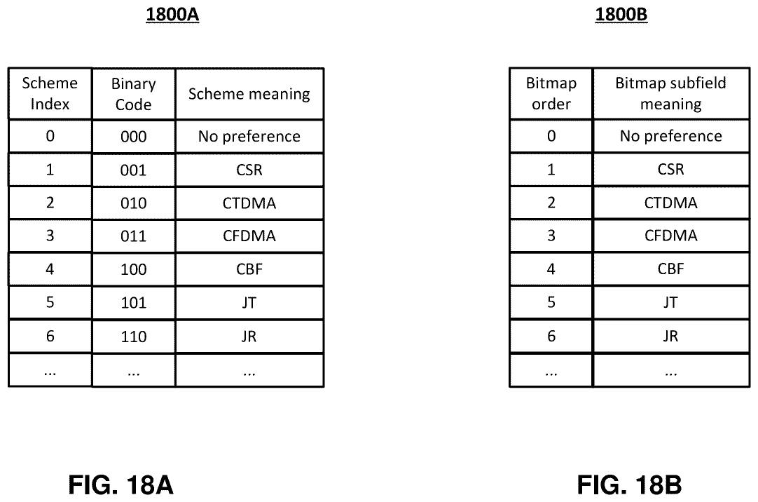

In an implementation, the indication by an AP of a multi-AP transmission scheme and/or of an update of a multi-AP transmission scheme may be encoded using a mapping as illustrated by example mapping 1800A of FIG. 18A or example mapping 1800B of FIG. 18B. As shown in FIG. 18A, the mapping 1800A associates a plurality of multi-AP transmission schemes with a respective plurality of indices. The indices may correspond to binary codes as shown in FIG. 18A. To signal a particular multi-AP transmission scheme and/or an update of a multi-AP transmission scheme, the corresponding code may be indicated in a field of the frame carrying the indication of the multi-AP transmission scheme and/or of the update of a multi-AP transmission scheme. As shown in FIG. 18B, the mapping 1800B associates a plurality of multi-AP transmission schemes with a respective plurality of sequences. The sequence may correspond to an order of a bitmap. To signal a particular multi-AP transmission scheme and/or an update of a multi-AP transmission scheme, the corresponding sequence may be indicated in a field of the frame carrying the indication of the multi-AP transmission scheme and/or of the update of a multi-AP transmission scheme.

As mentioned above, first frames 1642 and 1742 and third frames 1646 and 1746 may include management frames or data frames.

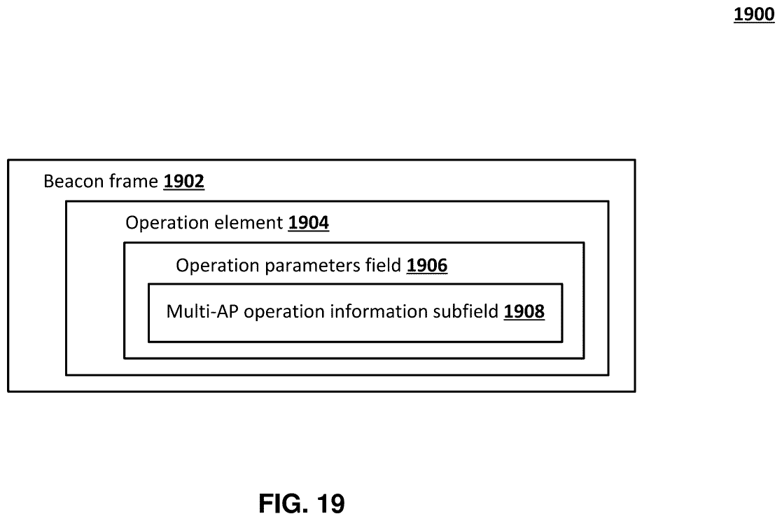

In an embodiment, frames 1642, 1646, 1742, and 1746 may be management frames, such as beacon frames. For example, the indication of the first multi-AP transmission scheme and/or the indication of the third multi-AP transmission scheme may be included in an operation element of a beacon frame. FIG. 19 illustrates an example 1900 of a beacon frame 1902 including an indication of a preferred multi-AP transmission scheme or of an update of the preferred multi-AP transmission scheme. As shown in FIG. 19, beacon frame 1902 may include an operation element 1904. The operation element 1904 may include an operation Parameters field 1906. The operation Parameters field 1906 may include a multi-AP operation information subfield 1908. In an embodiment, the multi-AP operation information subfield 1908 may include the indication of the preferred multi-AP transmission scheme or the indication of the update of the preferred multi-AP transmission scheme.

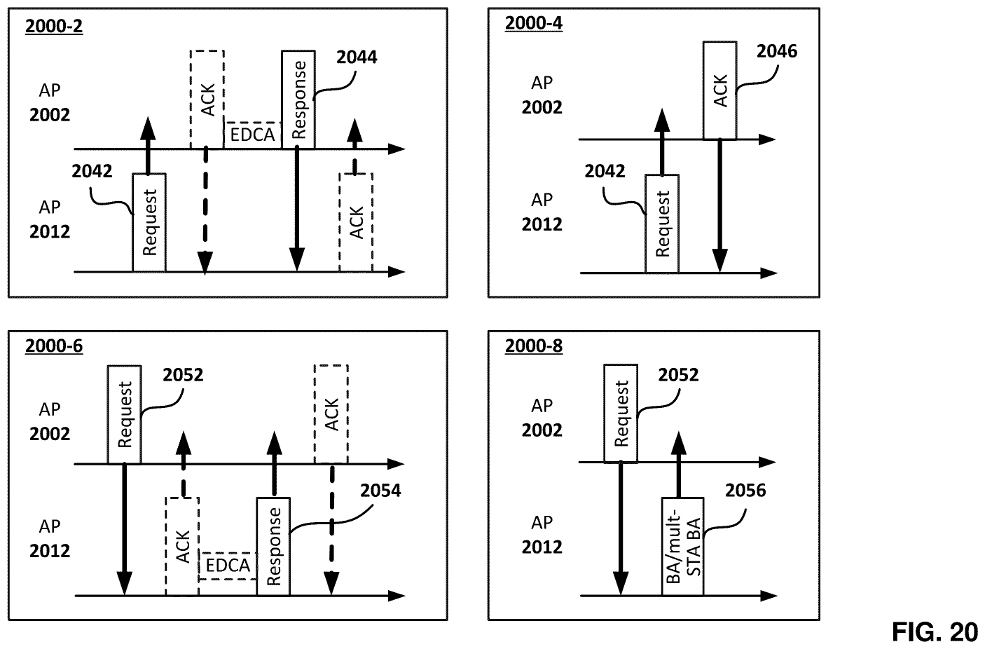

In another embodiment, frames 1642, 1646, 1742, and 1746 may be management frames, such as action frames or control frames. FIG. 20 illustrates examples 2000-2, 2000-4, 2000-6, and 2000-8 for procedures in which the indication of the first multi-AP transmission scheme and/or the indication of the third multi-AP transmission scheme may be provided in action or control frames. As described above, the first multi-AP transmission scheme may correspond to the scheme indicated in frames 1642 or 1742, while the third multi-AP transmission scheme may correspond to the scheme indicated in frames 1646 or 1746.

In examples 2000-2 and 2000-4, slave AP 2012 may transmit an action frame 2042 including the indication of the first multi-AP transmission scheme or the indication of the third multi-AP transmission scheme to master AP 2002. In an example, frame 2042 may be a public action frame. In an embodiment, frame 2042 may be a request frame providing BSS information of AP 2012 along with the indication of the preferred multi-AP transmission scheme for AP 2012 or the indication of the update of the preferred multi-AP transmission scheme for AP 2012. For example, frame 2042 may be a BSS information request frame. In an embodiment, frame 2042 may be a request frame providing the indication of the preferred multi-AP transmission scheme or the indication of the update of the preferred multi-AP transmission scheme for AP 2012. For example, frame 2042 may be a multi-AP information update request frame. Frame 2042 may include a Category field, a Public Action field, and a multi-AP information field. The multi-AP information field may include the indication of the preferred multi-AP transmission scheme or the indication of the update of the preferred multi-AP transmission scheme.

As shown in example 2000-2, AP 2002 receives frame 2042 and optionally transmits an ACK frame to AP 2012. After an optional period of EDCA, AP 2002 transmits a response frame 2044 to confirm the reception of frame 2042. AP 2012 may optionally transmit an ACK frame to AP 2002. By contrast, example 2000-4 shows a simplified procedure, in which the AP 2002 confirms the reception of frame 2042 by transmitting an ACK frame.

In examples 2000-6 and 2000-8, master AP 2002 may transmit an action frame 2052 to slave AP 2012 to request the indications of the first multi-AP transmission scheme or of the third multi-AP transmission scheme. In an embodiment, frame 2052 may be a request frame that requests the BSS information of AP 2012 along with the indication of the preferred multi-AP transmission scheme for AP 2012 or the indication of the update of the preferred multi-AP transmission scheme for AP 2012. For example, frame 2052 may be a BSS information request frame. In an embodiment, frame 2042 may be a request frame requesting the indication of the preferred multi-AP transmission scheme or the indication of the update of the preferred multi-AP transmission scheme for AP 2012. For example, frame 2052 may be a multi-AP information update request frame.

As shown in example 2000-6, AP 2012 receives frame 2052 and optionally transmits an ACK frame to AP 2002. After an optional period of EDCA, AP 2012 transmits a response frame 2054 to AP 2002 including the information requested by frame 2042. In an example, frame 2054 may be a public action frame. In an embodiment, frame 2054 includes the BSS information of the AP 2012 along with the indication of the preferred multi-AP transmission scheme for AP 2012 or the indication of the update of the preferred multi-AP transmission scheme for AP 2012. For example, frame 2054 may be a BSS information response frame. In an embodiment, frame 2054 provides the indication of the preferred multi-AP transmission scheme for AP 2012 or the indication of the update of the preferred multi-AP transmission scheme for AP 2012. For example, frame 2054 may be a multi-AP information update response frame. Frame 2054 may include a Category field, a Public Action field, and a multi-AP information field. The multi-AP information field may include the indication of the preferred multi-AP transmission scheme or the indication of the update of the preferred multi-AP transmission scheme. AP 2002 may optionally transmit an ACK frame to confirm the reception of frame 2054. By contrast, example 2000-8 shows a simplified procedure, in which AP 2012 transmits a control frame, for example, a BA frame or a multi-STA BA frame, including the indication of the preferred multi-AP transmission scheme for AP 2012 or the indication of the update of the preferred multi-AP transmission scheme for AP 2012.

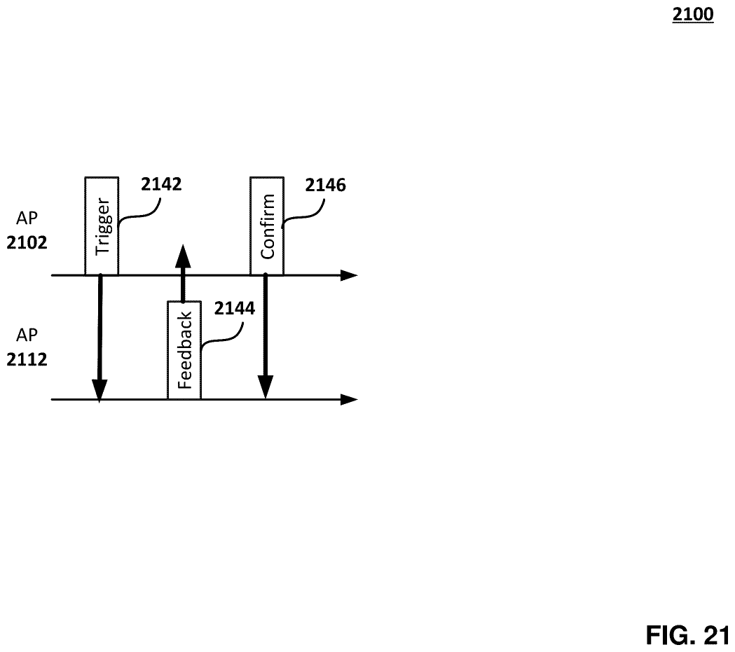

In an embodiment, frames 1642, 1646, 1742, and 1746 may be data frames. FIG. 21 illustrates an example 2100 of a procedure in which the indication of the first multi-AP transmission scheme and/or the indication of the third multi-AP transmission scheme may be provided in data frames. As described above, the first multi-AP transmission scheme may correspond to the scheme indicated in frames 1642 or 1742, while the third multi-AP transmission scheme may correspond to the scheme indicated in frames 1646 or 1746.

As shown in FIG. 21, master AP 2102 may transmit a trigger frame 2142 to solicit a trigger-based (TB) PPDU transmission from slave AP 2112. In an example, AP 2112 may be a candidate slave AP for a multi-AP transmission. As such, frame 2142 may be a multi-AP trigger frame that solicits AP 2112 whether AP 2112 wishes to participate in the multi-AP transmission. For example, frame 2142 may be a multi-AP selection trigger frame. In an embodiment, AP 2112 responds to frame 2142 with a frame 2144 that includes its intention to participate in the multi-AP transmission as well as an indication of a preferred multi-AP transmission scheme for AP 2112. The preferred multi-AP transmission scheme for AP 2112 may be the first multi-AP transmission scheme or the third multi-AP transmission schemes discussed in examples 1600 and 1700 above.

In another example, AP 2112 may be a designated slave AP for a multi-AP transmission. As such, frame 2142 may be a trigger frame that solicits from AP 2112 an indication of a preferred multi-AP transmission scheme or an indication of an update of the preferred multi-AP transmission scheme. For example, frame 2142 may be a multi-AP trigger frame. In an embodiment, AP 2112 responds to frame 2142 with a frame 2144 including the indication of the preferred multi-AP transmission scheme or the indication of the update of the preferred multi-AP transmission scheme for AP 2112. The preferred multi-AP transmission scheme or the update of the preferred multi-AP transmission scheme for AP 2112 may be the third multi-AP transmission scheme discussed in example 1600 or 1700 above.

In an embodiment, frame 2144 may be a QoS null frame. As described above with reference to FIG. 6, a QoS null frame refers to a QoS data frame with an empty frame body. For example, a QoS null frame may include, among other fields, a QoS control field and an HT control field. The QoS control field and/or the HT control field may include a BSR. In another embodiment, frame 2144 may be a QoS data frame, which includes similar fields as a QoS null frame. In an embodiment, where frame 2144 is a QoS null frame or a QoS data frame, the indication of the first multi-AP transmission scheme or the indication of the third multi-AP transmission scheme may be provided in the QoS Control field or the HT Control field of the QoS null frame or the QoS data frame.

In an embodiment, master AP 2102 may transmit to slave AP 2112 a frame 2146 confirming AP 2112 for participation in the multi-AP transmission with a multi-AP transmission scheme determined based on previously received frames. In an example, when frame 2144 includes the first multi-AP transmission scheme (e.g., frame 2144 is an embodiment of frame 1642 in example 1600), the determination of the multi-AP transmission scheme indicated in frame 2146 may be based on frame 2144. In an example, when frame 2144 includes the indication of the third multi-AP transmission scheme (e.g., frame 2144 is an embodiment of frame 1646 or 1746 in example 1600), the determination of the multi-AP transmission scheme indicated in frame 2146 may be based on the second and the third multi-AP transmission schemes discussed above as shown in example 1600.

Recalling example 1600 illustrated in FIG. 16, master AP 1602 may receive the third frame 1646 in various durations after receiving the first frame 1642. Similarly, in example 1700 illustrated in FIG. 17, master AP 1702 may receive the third frame 1746 in various durations after receiving first frame 1742. In embodiments, the third frame may be received at least a beacon interval, less than a beacon interval, at least a TXOP, or less than a TXOP, after receiving the first frame. In an embodiment, the various durations may be classified into a long-term, a medium-term, and a short-term category. The long-term category may include receiving the third frame at least a beacon interval after receiving the first frame. The medium-term category may include receiving the third frame less than a beacon interval but at least a TXOP after receiving the first frame. The short-term category may include receiving the third frame less than a TXOP after receiving the first frame. The long-term, medium-term, and short-term categories allow the master AP to determine the multi-AP transmission scheme based on both the latest preferred multi-AP transmission scheme for slave APs and the latest multi-AP transmission scheme determined by the master AP.

Referring to example 1900 of FIG. 19, example 2000 of FIG. 20 and example 2100 of FIG. 21, the first or third frame may belong to different frame types for different durations or categories of durations. Also, the first frame and the third frame may belong to different types for a given category of duration. In an embodiment, the first frame and the third frame include a management frame, such as a beacon frame and an action frame, a control frame, or a data frame. In an embodiment, the second frame and the fourth frame may be a control frame.

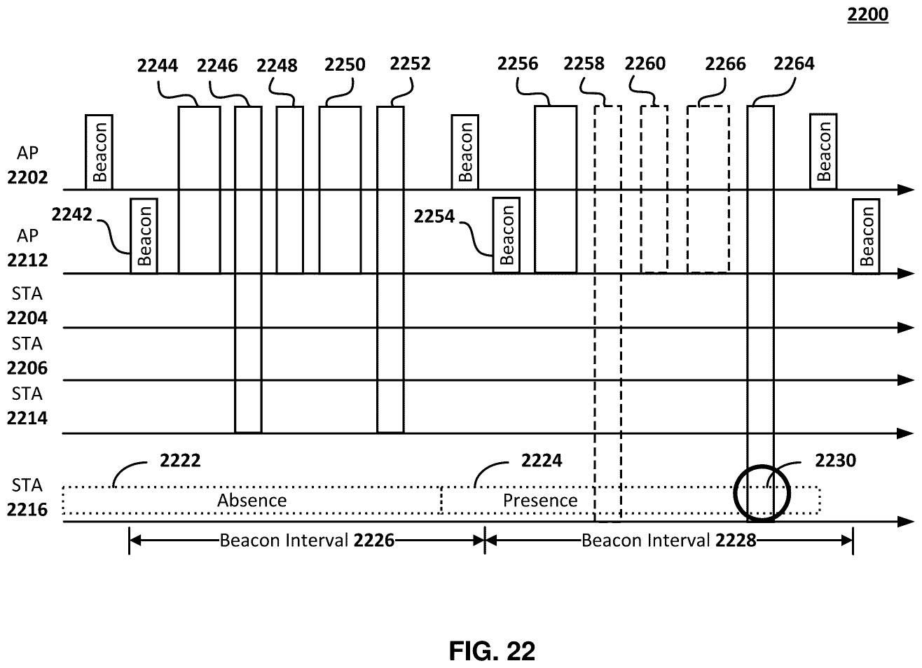

FIG. 22 illustrates an example 2200 of multi-AP operation according to the proposed procedure. Like example 1500 of FIG. 15, example 2200 may include a first BSS and a second BSS. The first BSS may include an AP 2202 and a plurality of STAs 2204 and 2206. STAs 2204 and 2206 may be associated with AP 2202. The second BSS may include an AP 2212 and a plurality of STAs 2214 and 2216. STAs 2214 and 2216 may be associated with AP 2212. In an example, AP 2202 and AP 2212 may form a multi-AP group. AP 2202 may be the master AP and AP 2212 may be a slave AP of the multi-AP group. AP 2202 and AP 2212 may exchange frames to set up multi-AP transmission and form a coordinated AP set. The coordinated AP set corresponds to the set of APs that participate in the multi-AP transmission. The coordinated AP set may be a part of a multi-AP group. In an embodiment, during a multi-AP setup phase, AP 2202 and AP 2212 may exchange frames to exchange capability information. In an example, AP 2202 may transmit to AP 2212 a first indication of support by AP 2202 of two or more multi-AP transmission schemes. In another example, AP 2202 may transmit to AP 2212 a second indication of support by AP 2202 of two or more multi-AP transmission schemes. In an embodiment, AP 2202 may transmit to AP 2212 a third indication of support by AP 2202 of a multi-AP transmission scheme selection capability. In another embodiment, AP 2212 may transmit to AP 2202 a fourth indication of support by AP 2212 of the multi-AP transmission scheme selection capability. It is assumed in example 2200 that both AP 2202 and AP 2212 support the multi-AP transmission scheme selection capability.

In an example, the status of STA 2216 may change over time. For example, STA 2216 may be absent during a first period 2222 and may be present during a second period 2224. In an example, STA 2204, 2206, 2214 are located in an area within signal coverage of both APs 2202 and 2212, while STA 2216 is located outside the signal coverage of AP 2202 but within the signal coverage of AP 2212. In an example, example 2200 may span a plurality of beacon intervals 2226 and 2228.

As shown in FIG. 22, example operation 2200 includes a plurality of phases as described above with reference to FIG. 9. The plurality of phases may span a plurality of beacon intervals, for example, beacon intervals 2226 and 2228. In an embodiment, AP 2202 receives a third frame 2254 (which is an embodiment of frame 1646 of example 1600) in period 2224 at least a beacon interval after receiving a first frame 2242 (which is an embodiment of frame 1642 of example 1600) in period 2222. In example 2200, slave AP 2212 transmits a first frame 2242, which may be a beacon frame, to master AP 2202 to start the multi-AP setup phase during the first period 2222. In an embodiment, the first frame 2242 includes an indication of the first multi-AP transmission scheme for use in the coordinated AP set, wherein the first multi-AP transmission scheme corresponds to the preferred multi-AP transmission scheme for AP 2212. In example 2200, the preferred multi-AP transmission scheme indicated in frame 2242 is joint transmission (JT). As discussed in example 1900, the indications of the first multi-AP transmission scheme may be included in the operation parameters field of an operation element of frame 2242.

As shown in FIG. 22, after the transmission of frame 2242, a multi-AP information exchange phase 2244 and a multi-AP sounding phase 2246 take place. Phases 2244 and 2246 are similar to phases 1544 and 1546 described above. In example 1500, master AP 1502 designates the slave AP 1512 and determines a multi-AP transmission scheme in phase 1548 based on the capabilities of AP 1512 supporting multi-AP transmission schemes indicated in frame 1542. In contrast to example 1500, in example 2200, master AP 2202 transmits a confirmation frame announcing the designed slave AP 2212 and a second multi-AP transmission scheme in multi-AP selection phase 2248. As discussed in example 1600, the second multi-AP transmission scheme corresponds to the multi-AP transmission scheme determined by master AP 2202 based on the first multi-AP transmission scheme indicated in the first frame 2242 for the coordinated AP set. In example 2200, AP 2202 adopts JT as the second multi-AP transmission scheme. Similar to example 1500, as AP 2212 is designated in example 2200, APs 2202 and 2212 may perform a multi-AP data sharing phase 2250 (which may be required for JT) followed by a multi-AP data transmission phase 2252 using JT with associated STAs 2204, 2206, 2214. In an example, master AP 2202 may transmit a second frame announcing the second multi-AP transmission scheme in multi-AP data sharing phase 2250, (e.g., the second frame may be similar to frame 1342 of example 1300). In another example, master AP 2202 may transmit the second frame announcing the second multi-AP transmission scheme in multi-AP data transmission phase 2252 (e.g., the second frame may be similar to frame 1442 of example 1400).

During period 2224, slave AP 2212 may transmit a third frame 2254, which may be a beacon frame, including an indication of a third multi-AP transmission scheme for the coordinated AP set. In an embodiment, frame 2254 is received by AP 2202 at least a beacon interval after the receiving first frame 2242. As discussed in example 1600, the third multi-AP transmission scheme may correspond to an update of the first multi-AP transmission scheme. Similar to frame 2242, the indications of the third multi-AP transmission scheme may be included in an operation parameters field of an operation element of frame 2254. In example 2200, the update of the first multi-AP transmission scheme indicated in frame 2254 is coordinated spatial reuse (CSR).

As shown in FIG. 22, after the transmission of frame 2254, APs 2202 and 2212 may perform a multi-AP information exchange phase 2256 and obtain information related to the presence of STA 2216 during period 2224. In an embodiment, AP 2202 determines the fourth multi-AP transmission scheme based on the second multi-AP transmission scheme announced in phase 2248 and the third multi-AP transmission scheme indicated in frame 2254. In example 2200, AP 2202 adopts CSR as the fourth multi-AP transmission scheme, without changing the slave AP 2212. Therefore, a multi-AP sounding phase 2258, a multi-AP selection phase 2260, and a multi-AP data sharing phase 2266 may be optional. AP 2202 may announce the fourth multi-AP transmissions scheme at the beginning of a multi-AP transmission data transmission phase 2264, for example, using a frame similar to frame 1442 described above with reference to FIG. 14. By performing CSR in phase 2264, all associated STAs in the multi-AP network can be served by APs 2022 and 2012, even with STA 2216 being out of the coverage of AP 2202. For example, upon coordination between APs 2202 and 2212 for spatial reuse, STAs 2204 and 2206 may successfully receive a data frame transmitted from AP 2202, while STAs 2214 and 2216 may successfully receive a data frame transmitted from AP 2212 (as illustrated by marker 2230 in FIG. 22).

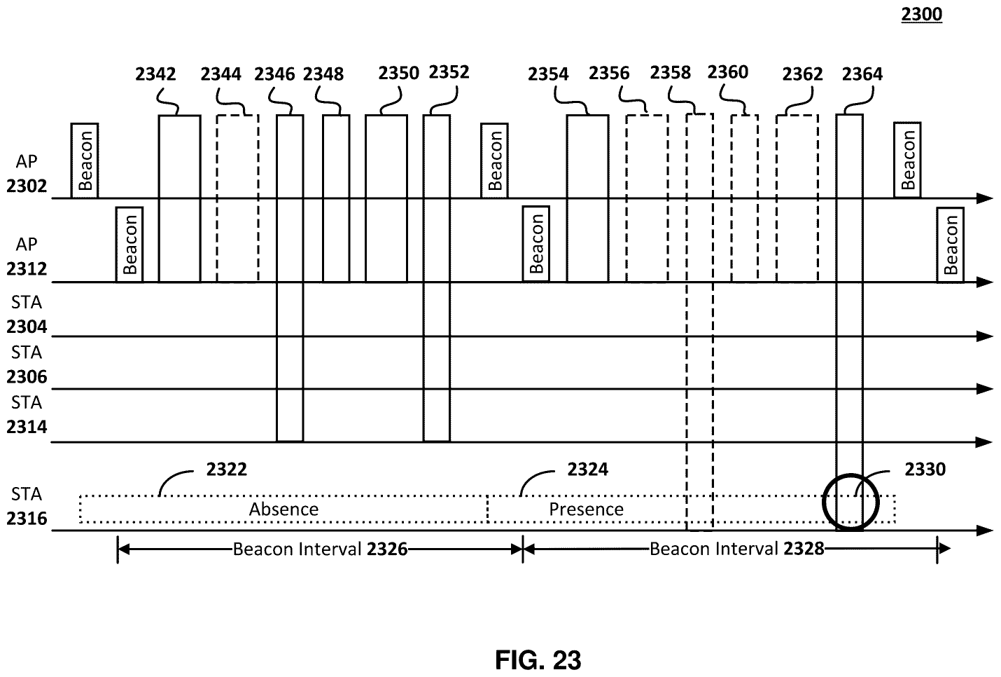

FIG. 23 illustrates an example 2300 of multi-AP operation according to the proposed procedure. Like example 2200 of FIG. 22, example 2300 may include a first BSS and a second BSS. The first BSS may include an AP 2302 and a plurality of STAs 2304 and 2306. STAs 2304 and 2306 may be associated with AP 2302. The second BSS may include an AP 2312 and a plurality of STAs 2314 and 2316. STAs 2314 and 2316 may be associated with AP 2312. In an example, AP 2302 and AP 2312 may form a multi-AP group. AP 2302 may be the master AP and AP 2312 may be a slave AP of the multi-AP group. AP 2302 and AP 2312 may exchange frames to set up a multi-AP transmission and form a coordinated AP set. The coordinated AP set corresponds to the set of APs that participate in the multi-AP transmission. The coordinated AP set may be a part of the multi-AP group. In an embodiment, during a multi-AP setup phase, AP 2302 and AP 2312 may exchange frames to exchange capability information. In an example, AP 2302 may transmit to AP 2312 a first indication of support by AP 2302 of two or more multi-AP transmission schemes. In another example, AP 2302 may transmit to AP 2312 a second indication of support by AP 2302 of two or more multi-AP transmission schemes. In an embodiment, AP 2302 may transmit to AP 2312 a third indication of support by AP 2302 of a multi-AP transmission scheme selection capability. In another embodiment, AP 2312 may transmit to AP 2302 a fourth indication of support by AP 2312 of the multi-AP transmission scheme selection capability. It is assumed in example 2300 that both AP 2302 and AP 2312 support the multi-AP transmission scheme selection capability.

In an embodiment, AP 2302 receives from AP 2312 a third frame in period 2324 as an action frame at least one beacon interval, for example, beacon interval 2326, after receiving a first frame from AP 2312 in period 2322. The first frame may include an indication of a first multi-AP transmission scheme for use in the coordinated AP set. The third frame may include an indication of a third multi-AP transmission scheme for the coordinated AP set. The first frame (which may correspond to frame 1642 of example 1600) may be received by AP 2302 in either a multi-AP information exchange phase 2342 or a multi-AP information update phase 2344 (the first frame may be similar to frames 2042, 2054, or 2056 from examples in FIG. 20). The third frame (which may correspond to frame 1646 of example 1600) may be received by AP 2302 in either a multi-AP information exchange phase 2354 or a multi-AP information update phase 2356 (the third frame may be similar to frames 2042, 2054, or 2056 from examples in FIG. 20).

In an embodiment, optional phases 2344 and 2356 may be absent in example 2300. In an embodiment, when the first frame is included in phase 2342, AP 2312 transmits the first frame including the indication of the first multi-AP transmission scheme together with BSS information to AP 2302. In an example, after the phase 2342, a multi-AP sounding phase 2346 takes place. Phase 2346 is similar to phase 1546 described above. In an embodiment, when the third frame is included in phase 2354, AP 2312 transmits the third frame including the indication of the third multi-AP transmission scheme together with an update of BSS information and link quality information related to STA 2316. In an example, after the phase 2354, an optional multi-AP sounding phase 2358 takes place. Phase 2358 is similar to phase 1558 described above.

In another embodiment, optional phases 2344 and 2356 may be present in example 2300. In an embodiment, when the first frame is included in phase 2344, AP 2312 transmits the first frame including the indication of the first multi-AP transmission scheme to AP 2302. In an example, after the phase 2344, a multi-AP sounding phase 2346 takes place. Phase 2346 is similar to phase 1546 described above. In an embodiment, when the third frame is included in phase 2356, AP 2312 transmits the third frame including the indication of the third multi-AP transmission scheme to AP 2302. AP 2312 may transmit to AP 2302 an update of BSS information and link quality information related to STA 2316 in either phase 2354 or 2356. In an example, after the phase 2356, an optional multi-AP sounding phase 2358 takes place. Phase 2358 is similar to phase 1558 described above.

In an example, to announce the second multi-AP transmission scheme for the coordinated AP set in period 2322, the second frame (which may correspond to frame 1644 of example 1600) may be transmitted by AP 2302 in multi-AP selection phase 2348 (e.g., the second frame may be similar to frame 1246 in example 1200). Similar to example 1500, as AP 2312 is designated in example 2300, APs 2302 and 2312 may perform a multi-AP data sharing phase 2350 (which may be required for JT) followed by a multi-AP data transmission phase 2352 using JT with associated STAs 2304, 2306, 2314. In an example, the second multi-AP transmission scheme is JT serving STAs 2304, 2306 and 2314 in multi-AP data transmission phase 2352. In an example, the second frame may be transmitted by AP 2302 in multi-AP data sharing phase 2350 (e.g., the second frame may be similar to frame 1342 of example 1300). In another example, the second frame may be transmitted by AP 2302 in multi-AP data transmission phase 2352, (e.g., the second frame may be similar to frame 1442 of example 1400).

In an embodiment, AP 2302 transmits a fourth frame (which may correspond to frame 1648 of example 1600) to announce the fourth multi-AP transmission scheme for coordinated AP set in period 2324. In an example, the fourth frame may be transmitted by AP 2302 in phase 2354 (the fourth frame may be similar to frame 2044 of example 2000-2). In an example, the fourth frame may be transmitted by AP 2302 in phase 2356 (the fourth frame may be similar to frame 2044 of example 2000-2). In an example, the fourth frame may be transmitted by AP 2302 in multi-AP data transmission phase 2364 (the fourth frame may be similar to frame 1442 in example 1400). In example 2300, AP 2302 adopts CSR as the fourth multi-AP transmission scheme, without changing the slave AP 2312. Therefore, a multi-AP sounding phase 2358, a multi-AP selection phase 2360, and a multi-AP data sharing phase 2362 may be optional. In example 2300, the fourth multi-AP transmission scheme is CSR serving STAs 2304, 2306, 2314 and 2316 in phase 2364, as indicated by marker 2330.

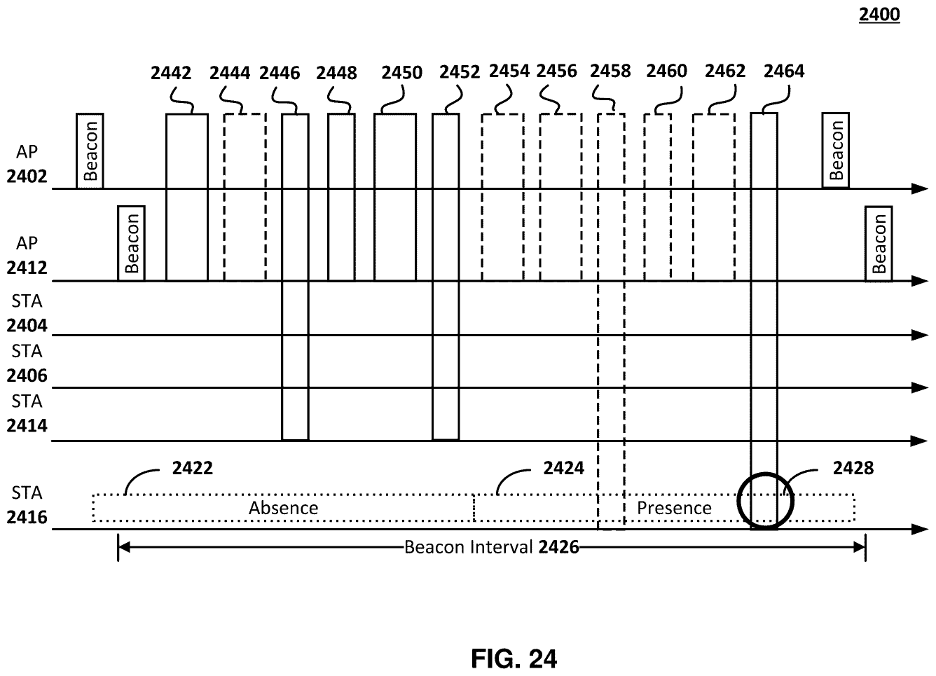

FIG. 24 illustrates an example 2400 of multi-AP operation according to the proposed procedure. Like example 2300 of FIG. 23, example 2400 may include a first BSS and a second BSS. The first BSS may include an AP 2402 and a plurality of STAs 2404 and 2406. STAs 2404 and 2406 may be associated with AP 2402. The second BSS may include an AP 2412 and a plurality of STAs 2414 and 2416. STAs 2414 and 2416 may be associated with AP 2412. In an example, AP 2402 and AP 2412 may form a multi-AP group. AP 2402 may be the master AP and AP 2412 may be a slave AP of the multi-AP group. AP 2402 and AP 2412 may exchange frames to set up a multi-AP transmission and form a coordinated AP set. The coordinated AP set corresponds to the set of APs that participate in the multi-AP transmission. The coordinated AP set may be a part of the multi-AP group. In an embodiment, during a multi-AP setup phase, AP 2402 and AP 2412 may exchange frames to exchange capability information. In an example, AP 2402 may transmit to AP 2412 a first indication of support by AP 2402 of two or more multi-AP transmission schemes. In another example, AP 2402 may transmit to AP 2412 a second indication of support by AP 2402 of two or more multi-AP transmission schemes. In an embodiment, AP 2402 may transmit to AP 2412 a third indication of support by AP 2402 of a multi-AP transmission scheme selection capability. In another embodiment, AP 2412 may transmit to AP 2402 a fourth indication of support by AP 2412 of the multi-AP transmission scheme selection capability. It is assumed in example 2400 that both AP 2402 and AP 2412 support the multi-AP transmission scheme selection capability.

In an embodiment, AP 2402 receives a third frame from AP 2412 in period 2424 within a beacon interval 2426 after receiving a first frame from AP 2412 in period 2422. The first frame includes an indication of a first multi-AP transmission scheme for use in the coordinated AP set, and the third frame includes an indication of a third multi-AP transmission scheme for the coordinated AP set.

In an embodiment, during period 2422, frame exchanges including the receiving of the first frame in a multi-AP info exchange phase 2442 or a multi-AP info update phase 2444 may take place. Phases 2442 and 2444 may be similar to phases 2342 and 2344 respectively described above with reference to example 2300. In an example, after the phase 2442, a multi-AP sounding phase 2446 takes place. Phase 2446 is similar to phase 1546 described above. Similar to example 1500, as AP 2412 is designated in example 2400, APs 2402 and 2412 may perform a multi-AP data sharing phase 2450 (which may be required for JT) followed by a multi-AP data transmission phase 2452 using JT with associated STAs 2404, 2406, 2414. In an example, AP 2402 may transmit a second frame to announce a second multi-AP transmission scheme for the coordinated AP set in period 2422. In an example, the second frame may be transmitted by AP 2402 in multi-AP selection phase 2448 (e.g., the second frame may be similar to frame 1246 of example 1200). In an example, the second frame may be transmitted by AP 2402 in multi-AP data sharing phase 2450 (e.g., the second frame may be similar to frame 1342 of example 1300). In another example, the second frame may be transmitted by AP 2402 in multi-AP data transmission phase 2452, (e.g., the second frame may be similar to frame 1442 of example 1400). Similarly, during period 2424, exchanges including the receiving of the third frame in a multi-AP info exchange phase 2454 or a multi-AP info update phase 2456 may take place. Phases 2454 and 2456 may be similar to phases 2354 and 2356 respectively described above with reference to example 2300. In an example, after the phase 2456, an optional multi-AP sounding phase 2458 takes place. Phase 2458 is similar to phase 1558 described above. In example 2400, AP 2402 adopts CSR as the fourth multi-AP transmission scheme, without changing the slave AP 2412. Therefore, a multi-AP sounding phase 2458, a multi-AP selection phase 2460, and a multi-AP data sharing phase 2462 may be optional. In example 2400, the fourth multi-AP transmission scheme is CSR serving STAs 2404, 2406, 2414 and 2416 in a multi-AP data transmission phase 2464, as indicated by marker 2430.

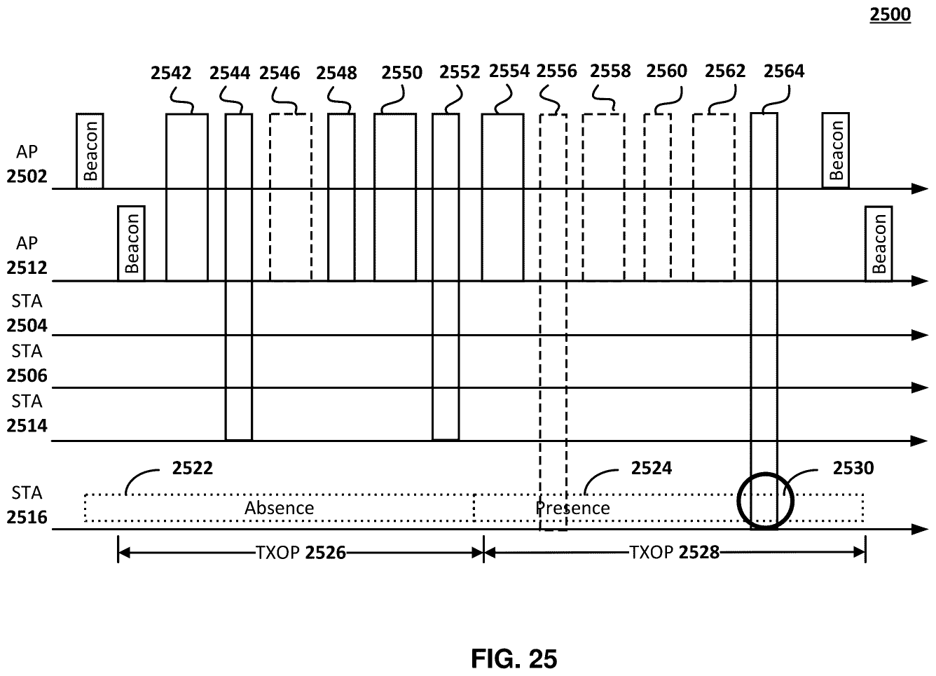

FIG. 25 illustrates an example 2500 for multi-AP operation using the proposed procedure. Like example 2400 of FIG. 24, example 2500 may include a first BSS and a second BSS. The first BSS may include an AP 2502 and a plurality of STAs 2504 and 2506. STAs 2504 and 2506 may be associated with AP 2502. The second BSS may include an AP 2512 and a plurality of STAs 2514 and 2516. STAs 2514 and 2516 may be associated with AP 2512. In an example, AP 2502 and AP 2512 may form a multi-AP group. AP 2502 may be the master AP and AP 2512 may be a slave AP of the multi-AP group. AP 2502 and AP 2512 may exchange frames to set up a multi-AP transmission and form a coordinated AP set. The coordinated AP set corresponds to the set of APs that participate in the multi-AP transmission. The coordinated AP set may be a part of the multi-AP group. In an embodiment, during a multi-AP setup phase, AP 2502 and AP 2512 may exchange frames to exchange capability information. In an example, AP 2502 may transmit to AP 2512 a first indication of support by AP 2502 of two or more multi-AP transmission schemes. In another example, AP 2502 may transmit to AP 2512 a second indication of support by AP 2502 of two or more multi-AP transmission schemes. In an embodiment, AP 2502 may transmit to AP 2512 a third indication of support by AP 2502 of a multi-AP transmission scheme selection capability. In another embodiment, AP 2512 may transmit to AP 2502 a fourth indication of support by AP 2512 of the multi-AP transmission scheme selection capability. It is assumed in example 2500 that both AP 2502 and AP 2512 support the multi-AP transmission scheme selection capability.

In an embodiment, AP 2502 receives a third frame from AP 2512 in period 2524 at least a TXOP duration, for example, TXOP 2526, after receiving a first frame in period 2522. The first frame includes an indication of a first multi-AP transmission scheme for use in the coordinated AP set, and the third frame includes an indication of a third multi-AP transmission scheme for the coordinated AP set.

In an example, during period 2522, after the transmission of a beacon frame, a multi-AP information exchange phase 2542 and a multi-AP sounding phase 2544 take place. Phases 2542 and 2544 are similar to phases 1544 and 1546 described above. In an embodiment, during period 2522, frame exchanges including the receiving of the first frame in a multi-AP coordination update phase 2546 or a multi-AP selection phase 2548 may take place. Frame exchanges for phases 2546 and 2548 may be similar to the procedures regarding frames 2142, 2144, and 2146 in example 2100 of FIG. 21. In an example, AP 2512 is designated in example 2500, APs 2502 and 2512 may perform a multi-AP data sharing phase 2550 (which may be required for JT) followed by a multi-AP data transmission phase 2552 using JT with associated STAs 2504, 2506, 2514. In an example, AP 2502 may transmit a second frame to announce a second multi-AP transmission scheme for the coordinated AP set in period 2522. In an example, the second frame may be transmitted by AP 2502 in multi-AP selection phase 2548 (e.g., the second frame may be similar to frame 1246 of example 1200). In an example, the second frame may be transmitted by AP 2502 in multi-AP data sharing phase 2550 (e.g., the second frame may be similar to frame 1342 of example 1300). In another example, the second frame may be transmitted by AP 2502 in multi-AP data transmission phase 2552 (e.g., the second frame may be similar to frame 1442 of example 1400). In an example, after the frame exchanges in phase 2552, a multi-AP information exchange phase 2554 and an optional multi-AP sounding phase 2556 take place. Phases 2554 and 2556 are similar to phases 1544 and 1546 described above. Similarly, during period 2524, frame exchanges including the receiving of the third frame in a multi-AP coordination update phase 2558 or a multi-AP selection phase 2560 may take place. Frame exchanges for phases 2558 and 2560 may be similar to the procedures regarding frames 2142, 2144, and 2146 in example 2100 of FIG. 21. In example 2500, during period 2524, AP 2502 adopts CSR as the fourth multi-AP transmission scheme, without changing the slave AP 2512. Therefore, a multi-AP data sharing phase 2562 may be optional. In example 2500, the fourth multi-AP transmission scheme is CSR serving STAs 2504, 2406, 2514 and 2516 in a multi-AP data transmission phase 2564, as indicated by marker 2530.

In an example, when the optional phase 2560 is present in example 2500, the optional phases 2546 and 2558 may be absent. In an embodiment, when the AP 2512 transmits the first frame in phase 2548, the first frame may be similar to frame 2144 of example 2100. The first frame may include the indication of the first multi-AP transmission scheme together with an indication of the intention of AP 2512 to participate in a multi-AP transmission. In an embodiment, when AP 2512 transmits the third frame in phase 2560, the third frame may be similar to frame 2144 of example 2100. The third frame may include the indication of the third multi-AP transmission scheme together with an indication of the intention of AP 2512 to participate in a multi-AP transmission. The second frame announcing the second multi-AP transmission scheme may be similar to frame 2146 of example 2100 transmitted by AP 2502 in phases 2548, while the fourth frame announcing the fourth multi-AP transmission scheme may be similar to frame 2146 of example 2100 transmitted by AP 2502 in phases 2560.

In an example, when the optional phase 2560 is present in example 2500, the optional phases 2546 and 2558 may be also present. In an embodiment, when the AP 2512 transmits the first frame in phase 2546, the first frame may be similar to frame 2144 of example 2100. The first frame may include the indication of the first multi-AP transmission scheme. In an embodiment, when AP 2512 transmits the third frame in phase 2558, the third frame may be similar to frame 2144 of example 2100. The third frame may include the indication of the third multi-AP transmission scheme. AP 2512 may transmit to AP 2502 an update of BSS information and link quality information related to STA 2316 in multi-AP info exchange phase 2554. The second frame announcing the second multi-AP transmission scheme may be similar to frame 2146 of example 2100 transmitted by AP 2502 in phase 2548, while the fourth frame announcing the fourth multi-AP transmission scheme may be similar to frame 2146 of example 2100 transmitted by AP 2502 in phase 2560.

In an example, when the optional phase 2560 is absent in example 2500, the optional phase 2558 is present. In an embodiment, when the AP 2512 transmits the third frame in phase 2558, the third frame may be similar to frame 2144 of example 2100. The third frame may include the indication of the third multi-AP transmission scheme. The second frame announcing the second multi-AP transmission scheme may be similar to frame 2146 of example 2100 transmitted by AP 2502 in phase 2548, while the fourth frame announcing the fourth multi-AP transmission scheme may be similar to frame 2146 of example 2100 transmitted by AP 2502 in phase 2558.

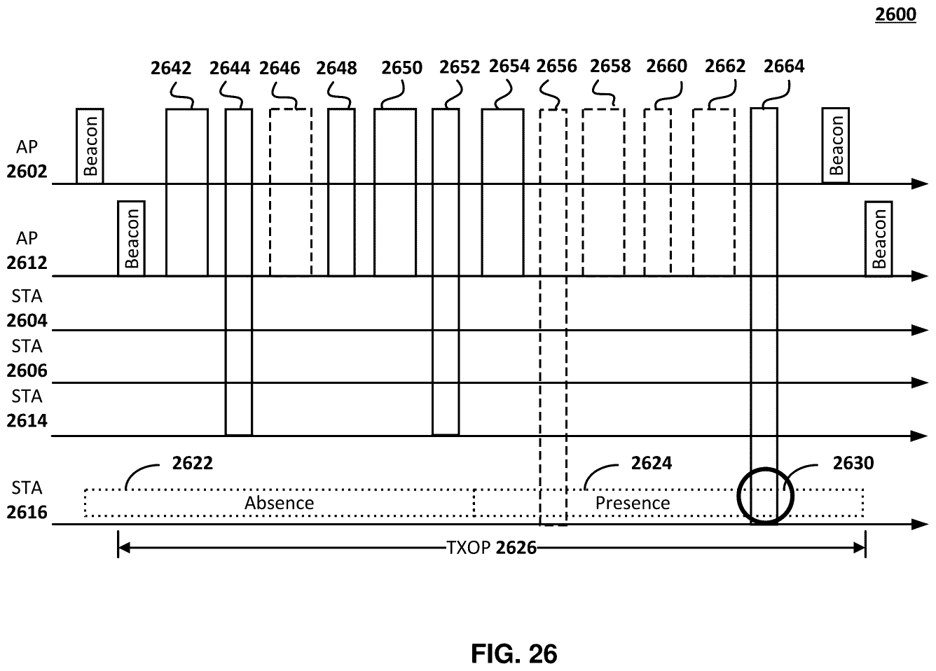

FIG. 26 illustrates an example 2600 for multi-AP operation using the proposed procedure. Like example 2500 of FIG. 25, example 2400 may include a first BSS and a second BSS. The first BSS may include an AP 2602 and a plurality of STAs 2604 and 2606. STAs 2604 and 2606 may be associated with AP 2602. The second BSS may include an AP 2612 and a plurality of STAs 2614 and 2616. STAs 2614 and 2616 may be associated with AP 2612. In an example, AP 2602 and AP 2612 may form a multi-AP group. AP 2602 may be the master AP and AP 2612 may be a slave AP of the multi-AP group. AP 2602 and AP 2612 may exchange frames to set up a multi-AP transmission and form a coordinated AP set. The coordinated AP set corresponds to the set of APs that participate in the multi-AP transmission. The coordinated AP set may be a part of the multi-AP group. In an embodiment, during a multi-AP setup phase, AP 2602 and AP 2612 may exchange frames to exchange capability information. In an example, AP 2602 may transmit to AP 2612 a first indication of support by AP 2602 of two or more multi-AP transmission schemes. In another example, AP 2602 may transmit to AP 2612 a second indication of support by AP 2602 of two or more multi-AP transmission schemes. In an embodiment, AP 2602 may transmit to AP 2612 a third indication of support by AP 2602 of a multi-AP transmission scheme selection capability. In another embodiment, AP 2612 may transmit to AP 2602 a fourth indication of support by AP 2612 of the multi-AP transmission scheme selection capability. It is assumed in example 2600 that both AP 2602 and AP 2612 support the multi-AP transmission scheme selection capability.

In an embodiment, AP 2602 receives a third frame in period 2624 within less than a TXOP duration, for example, 2526, after receiving a first frame in period 2622. The first frame includes the indication of the first multi-AP transmission scheme for use in the coordinated AP set, and the third frame includes the indication of the third multi-AP transmission scheme for the coordinated AP set.

In an example, during period 2622, after the transmission of a beacon frame, a multi-AP information exchange phase 2642 and a multi-AP sounding phase 2644 take place. Phases 2642 and 2644 are similar to phases 1544 and 1546 described above. In an embodiment, during period 2622, frame exchanges including the receiving of the first frame in multi-AP coordination update phase 2646 or multi-AP selection phase 2648 may take place. Frame exchanges for phase 2646 and 2648 may be similar to the procedures regarding frames 2142, 2144, and 2146 in example 2100 of FIG. 21. In an example, AP 2612 is designated in example 2600, APs 2602 and 2612 may perform a multi-AP data sharing phase 2650 (which may be required for JT) followed by a multi-AP data transmission phase 2652 using JT with associated STAs 2604, 2606, 2614. In an example, AP 2602 may transmit a second frame to announce a second multi-AP transmission scheme for the coordinated AP set in period 2622. In an example, the second frame may be transmitted by AP 2602 in multi-AP selection phase 2648, (e.g., the second frame may be similar to frame 1246 of example 1200). In an example, the second frame may be transmitted by AP 2602 in multi-AP data sharing phase 2650, (e.g., the second frame may be similar to frame 1342 of example 1300). In another example, the second frame may be transmitted by AP 2602 in multi-AP data transmission phase 2652, (e.g., the second frame may be similar to frame 1442 of example 1400). In an example, after the frame exchanges in phase 2652, a multi-AP information exchange phase 2654 and an optional multi-AP sounding phase 2656 take place. Phases 2654 and 2656 are similar to phases 1544 and 1546 described above. Similarly, during period 2624, frame exchanges including the receiving of the third frame in multi-AP coordination update phase 2658 or multi-AP selection phase 2660 may take place. Frame exchanges for phase 2658 and 2660 may be similar to the procedures regarding frames 2142, 2144, and 2146 in example 2100 of FIG. 21. In an embodiment, frame exchanges in phases 2646, 2648, 2658 and 2660 of example 2600 may be similar to the frame exchanges in phases 2546, 2548, 2558 and 2560 of example 2500 described above. In example 2600, during period 2624, AP 2602 adopts CSR as the fourth multi-AP transmission scheme, without changing the slave AP 2612. Therefore, a multi-AP data sharing phase 2662 may be optional. In example 2600, the fourth multi-AP transmission scheme is CSR serving STAs 2604, 2406, 2614 and 2616 in a multi-AP data transmission phase 2664, as indicated by marker 2630.

As would be understood by a person of skill in the art based on the teachings herein, the embodiments as described above in examples 2200, 2300, 2400, 2500, and 2600 may be readily extended to cases including more than two APs (e.g., three APs as illustrated in example 1700 of FIG. 17). As in the case involving two APs, the third frame may be received by the master AP at various durations after receiving the first frame, e.g., at least a beacon interval, less than a beacon interval, at least a TXOP, or less than a TXOP, after receiving the first frame.

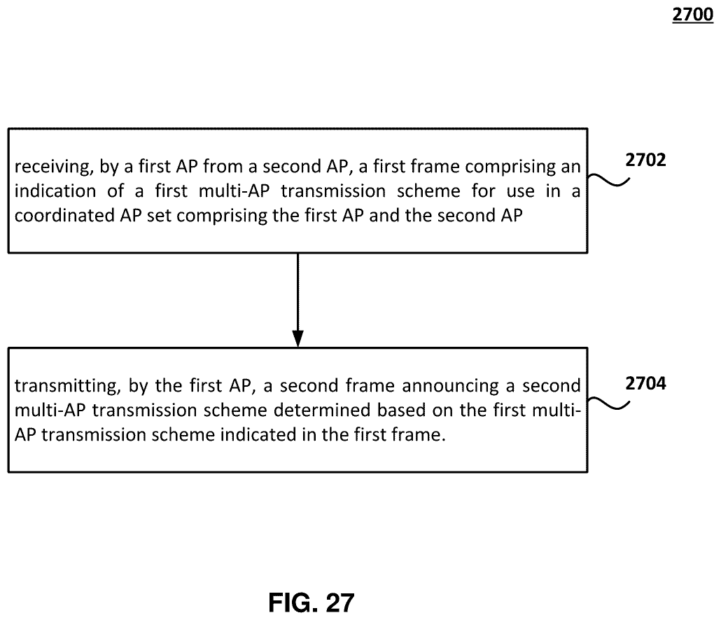

FIG. 27 illustrates an example process 2700 according to an embodiment. Example process 2700 is provided for the purpose of illustration only and is not limiting of embodiments. Process 2700 may be performed by a first AP. The first AP may be a master AP of a coordinated AP set.

As shown in FIG. 27, process 2700 begins in step 2702, which includes receiving, by a first AP from a second AP, a first frame comprising an indication of a first multi-AP transmission scheme for use in a coordinated AP set comprising the first AP and the second AP.

In an embodiment, the first multi-AP transmission scheme corresponds to a preferred multi-AP transmission scheme for the second AP for use in the coordinated AP set. In an embodiment, the first AP and the second AP belong to different BSSs.

In an embodiment, the first frame comprises a management frame. In an embodiment, the management frame comprises a beacon frame. In an embodiment, the management frame comprises an action frame. In an embodiment, the management frame comprises an operations element comprising the indication of the first multi-AP transmission scheme. In an embodiment, the action frame comprises BSS information comprising the indication of the first multi-AP transmission scheme. In an embodiment, the action frame is communicated in a multi-AP information exchange phase. In an embodiment, the action frame comprises a multi-AP information update request frame or a multi-AP information update response frame. In an embodiment, the multi-AP information update request frame or the multi-AP information update response frame comprises a preferred scheme field comprising the indication of the first multi-AP transmission scheme. In an embodiment, the multi-AP information update request frame or the multi-AP information update response frame is communicated in a multi-AP information update phase.

In an embodiment, the first frame comprises a data frame. In an embodiment, the data frame comprises a feedback frame to a multi-AP trigger frame. In an embodiment, the multi-AP trigger frame comprises a multi-AP selection trigger frame, and wherein the multi-AP trigger frame is communicated in a multi-AP selection phase. In an embodiment, the multi-AP trigger frame is communicated in a multi-AP coordination update phase. In an embodiment, the multi-AP trigger frame is communicated in a multi-AP data transmission phase. In an embodiment, the feedback frame comprises a QoS control field comprising the indication of the first multi-AP transmission scheme. In an embodiment, the feedback frame comprises an HT control field comprising the indication of the first multi-AP transmission scheme. In an embodiment, the feedback frame is communicated in a multi-AP selection phase. In an embodiment, the feedback frame is communicated in a multi-AP coordination update phase.

In an embodiment, before step 2702, process 2700 may further include transmitting, by the first AP, a fifth frame comprising an indication of a fifth multi-AP transmission scheme for the coordinated set comprising the first AP and the second AP. In an embodiment, the fifth frame is transmitted before the receiving of the first frame. In an embodiment, the fifth multi-AP transmission scheme corresponds to a preferred multi-AP transmission scheme for the first AP for use in the coordinated AP set. In an embodiment, the fifth frame further comprises a request for the second AP to use the fifth multi-AP transmission scheme for the coordinated set. In an embodiment, the first frame further comprises a rejection in response to the fifth frame.

As shown in FIG. 27, in step 2704, process 2700 includes transmitting, by the first AP, a second frame announcing a second multi-AP transmission scheme determined based on the first multi-AP transmission scheme indicated in the first frame.

In an embodiment, the second frame comprises a control frame. In an embodiment, the second frame is communicated in a multi-AP selection phase, a multi-AP coordination update phase, a multi-AP data sharing phase, or a multi-AP data transmission phase.

In an embodiment, the second multi-AP transmission scheme is the same as or different than the first multi-AP transmission scheme.

In an embodiment, after step 2704, process 2700 may further include receiving, by the first AP from the second AP, a third frame comprising an indication of a third multi-AP transmission scheme for the coordinated AP set. In an embodiment, the third frame is received at least a beacon interval after the receiving of the first frame. In an embodiment, the first frame and the third frame comprise a beacon frame, an action frame, etc. In an embodiment, the third frame is received less than a beacon interval after the receiving of the first frame. In an embodiment, the first frame and the third frame comprise an action frame, a multi-AP information update request frame, or a multi-AP information update response frame. In an embodiment, the third frame is received at least a TXOP duration after the receiving of the first frame. In an embodiment, the third frame is received less than a TXOP duration after the receiving of the first frame. In an embodiment, the first frame and the third frame comprise a feedback frame to a multi-AP trigger frame. In an embodiment, the third multi-AP transmission scheme is an update of the first multi-AP transmission scheme for the second AP. In an embodiment, the third multi-AP transmission scheme is different from the first multi-AP transmission scheme or the second multi-AP transmission scheme.

In an embodiment, after step 2704, process 2700 may further include transmitting, by the first AP, a fourth frame announcing a fourth multi-AP transmission scheme determined based on the second multi-AP transmission scheme and the third multi-AP transmission scheme.

In an embodiment, after step 2704, process 2700 may further include receiving, by the first AP from a third AP, a third frame comprising an indication of a third multi-AP transmission scheme for the coordinated AP set comprising the first AP, the second AP, and the third AP. In an embodiment, the third multi-AP transmission scheme corresponds to a preferred multi-AP transmission scheme for the third AP for the coordinated AP set. In an embodiment, the third frame is received before the transmitting of the second frame. In an embodiment, the third frame is received less than a TXOP duration after the receiving of the first frame. In an embodiment, the first frame and the third frame comprise: a beacon frame, an action frame, a data frame, a multi-AP information update request frame, or a multi-AP information update response frame, a feedback frame to a multi-AP trigger frame, etc.

In an embodiment, after step 2704, process 2700 may further include determining, by the first AP, a fourth multi-AP transmission scheme for the coordinated AP set based on the first multi-AP transmission scheme and the third multi-AP transmission scheme. In an embodiment, process 2700 may further include transmitting, by the first AP, a fourth frame announcing the fourth multi-AP transmission scheme. In an embodiment, the fourth frame is the second frame. In an embodiment, the fourth multi-AP transmission scheme is the same as the first multi-AP transmission scheme or the third multi-AP transmission scheme or different than the first multi-AP transmission scheme and the third multi-AP transmission scheme.

In an embodiment, after step 2704, process 2700 may further include receiving, by the first AP from a third AP, a third frame comprising an indication of a third multi-AP transmission scheme for the coordinated AP set comprising the first AP, the second AP, and the third AP. In an embodiment, the third frame is received after the transmitting of the second frame. In an embodiment, the third frame is received less than a beacon interval after the receiving of the first frame. In an embodiment, the third frame is received at least a TXOP duration after the receiving of the first frame. In an embodiment, the third frame is received less than a TXOP duration after the receiving of the first frame. In an embodiment, the first frame and the third frame comprise: a beacon frame, an action frame, a data frame, a multi-AP information update request frame, or a multi-AP information update response frame, a feedback frame to a multi-AP trigger frame, etc.

In an embodiment, after step 2704, process 2700 may further include determining, by the first AP, a fourth multi-AP transmission scheme for the coordinated AP set based on the second multi-AP transmission scheme and the third multi-AP transmission scheme. In an embodiment, process 2700 may further include transmitting, by the first AP, a fourth frame announcing the fourth multi-AP transmission scheme. In an embodiment, the fourth multi-AP transmission scheme is the same as the second multi-AP transmission scheme or the third multi-AP transmission scheme or different from the second multi-AP transmission scheme and the third multi-AP transmission scheme.

In an embodiment, the receiving of the first frame occurs during a setup phase of the coordinated AP set. In an embodiment, the receiving of the first frame occurs after a setup phase of the coordinated AP set.

In an embodiment, the indication of the first multi-AP transmission scheme indicates no preference for a multi-AP transmission scheme. In an embodiment, the indication of the preferred multi-AP transmission scheme indicates coordinated spatial reuse (CSR), coordinated transmission opportunity (C-TXOP), coordinated time-division multiple-access (C-TDMA), coordinated frequency-division multiple-access (C-FDMA), coordinated beamforming (CBF), joint transmission (JT), or joint reception (JR), etc.

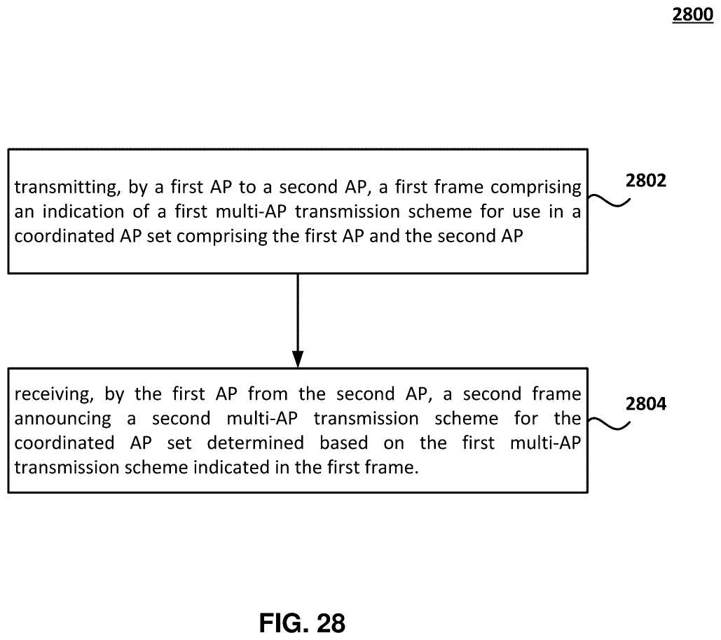

FIG. 28 illustrates an example process 2800 according to an embodiment. Example process 2800 is provided for the purpose of illustration only and is not limiting of embodiments. Process 2800 may be performed by a first AP. The first AP may be a slave AP of a coordinated AP set.

As shown in FIG. 28, process 2800 begins in step 2802, which includes transmitting, by a first AP from a second AP, a first frame comprising an indication of a first multi-AP transmission scheme for use in a coordinated AP set comprising the first AP and the second AP.

In an embodiment, the first multi-AP transmission scheme corresponds to a preferred multi-AP transmission scheme for the first AP for use in the coordinated AP set. In an embodiment, the first AP and the second AP belong to different BSSs.

In an embodiment, the first frame comprises a management frame. In an embodiment, the management frame comprises a beacon frame. In an embodiment, the management frame comprises an action frame. In an embodiment, the management frame comprises an operations element comprising the indication of the first multi-AP transmission scheme. In an embodiment, the action frame comprises BSS information comprising the indication of the first multi-AP transmission scheme. In an embodiment, the action frame is communicated in a multi-AP information exchange phase. In an embodiment, the action frame comprises a multi-AP information update request frame or a multi-AP information update response frame. In an embodiment, the multi-AP information update request frame or the multi-AP information update response frame comprises a preferred scheme field comprising the indication of the first multi-AP transmission scheme. In an embodiment, the multi-AP information update request frame or the multi-AP information update response frame is communicated in a multi-AP information update phase.

In an embodiment, the first frame comprises a data frame. In an embodiment, the data frame comprises a feedback frame to a multi-AP trigger frame. In an embodiment, the multi-AP trigger frame comprises a multi-AP selection trigger frame, and wherein the multi-AP trigger frame is communicated in a multi-AP selection phase. In an embodiment, the multi-AP trigger frame is communicated in a multi-AP coordination update phase. In an embodiment, the multi-AP trigger frame is communicated in a multi-AP data transmission phase. In an embodiment, the feedback frame comprises a QoS control field comprising the indication of the first multi-AP transmission scheme. In an embodiment, the feedback frame comprises an HT control field comprising the indication of the first multi-AP transmission scheme. In an embodiment, the feedback frame is communicated in a multi-AP selection phase. In an embodiment, the feedback frame is communicated in a multi-AP coordination update phase.

In an embodiment, before step 2802, process 2800 may further include receiving, by the first AP from the second AP, a fifth frame comprising an indication of a fifth multi-AP transmission scheme for the coordinated set comprising the first AP and the second AP. In an embodiment, the fifth frame is received before the transmitting of the first frame. In an embodiment, the fifth multi-AP transmission scheme corresponds to a preferred multi-AP transmission scheme for the second AP for use in the coordinated AP set. In an embodiment, the fifth frame further comprises a request for the first AP to use the fifth multi-AP transmission scheme for the coordinated set. In an embodiment, the first frame further comprises a rejection in response to the fifth frame.

As shown in FIG. 28, in step 2804, process 2800 includes receiving, by the first AP from the second AP, a second frame announcing a second multi-AP transmission scheme determined based on the first multi-AP transmission scheme indicated in the first frame.

In an embodiment, the second frame comprises a control frame. In an embodiment, the second frame is communicated in a multi-AP selection phase, a multi-AP coordination update phase, a multi-AP data sharing phase, or a multi-AP data transmission phase.

In an embodiment, the second multi-AP transmission scheme is the same as or different than the first multi-AP transmission scheme.

In an embodiment, after step 2804, process 2800 may further include transmitting, by the first AP to the second AP, a third frame comprising an indication of a third multi-AP transmission scheme for the coordinated AP set. In an embodiment, the third frame is transmitted at least a beacon interval after the transmitting of the first frame. In an embodiment, the first frame and the third frame comprise a beacon frame, an action frame, etc. In an embodiment, the third frame is transmitted less than a beacon interval after the transmitting of the first frame. In an embodiment, the first frame and the third frame comprise an action frame, a multi-AP information update request frame, or a multi-AP information update response frame. In an embodiment, the third frame is transmitted at least a TXOP duration after the transmitting of the first frame. In an embodiment, the third frame is transmitted less than a TXOP duration after the transmitting of the first frame. In an embodiment, the first frame and the third frame comprise a feedback frame to a multi-AP triggerframe. In an embodiment, the third multi-AP transmission scheme is an update of the first multi-AP transmission scheme for the first AP. In an embodiment, the third multi-AP transmission scheme is different from the first multi-AP transmission scheme or the second multi-AP transmission scheme.

In an embodiment, after step 2804, process 2800 may further include receiving, by the first AP from the second AP, a fourth frame announcing a fourth multi-AP transmission scheme determined based on the second multi-AP transmission scheme and the third multi-AP transmission scheme.

In an embodiment, after step 2804, process 2800 may further include transmitting, by the first AP to a third AP, a third frame comprising an indication of a third multi-AP transmission scheme for the coordinated AP set comprising the first AP, the second AP, and the third AP. In an embodiment, the third multi-AP transmission scheme corresponds to a preferred multi-AP transmission scheme for the third AP for the coordinated AP set. In an embodiment, the third frame is transmitted before the receiving of the second frame. In an embodiment, the third frame is transmitting less than a TXOP duration after the transmitting of the first frame. In an embodiment, the first frame and the third frame comprise: a beacon frame, an action frame, a data frame, a multi-AP information update request frame, or a multi-AP information update response frame, a feedback frame to a multi-AP trigger frame, etc.

In an embodiment, after step 2804, process 2800 may further include receiving, by the first AP, a fourth frame announcing the fourth multi-AP transmission scheme for the coordinated AP set determined based on the first multi-AP transmission scheme and the third multi-AP transmission scheme. In an embodiment, the fourth frame is the second frame. In an embodiment, the fourth multi-AP transmission scheme is the same as the first multi-AP transmission scheme or the third multi-AP transmission scheme or different than the first multi-AP transmission scheme and the third multi-AP transmission scheme.

In an embodiment, after step 2804, process 2800 may further include transmitting, by the first AP from a third AP, a third frame comprising an indication of a third multi-AP transmission scheme for the coordinated AP set comprising the first AP, the second AP, and the third AP. In an embodiment, the third frame is transmitted after the receiving of the second frame. In an embodiment, the third frame is transmitted less than a beacon interval after the transmitting of the first frame. In an embodiment, the third frame is transmitted at least a TXOP duration after the transmitting of the first frame. In an embodiment, the third frame is transmitted less than a TXOP duration after the transmitting of the first frame. In an embodiment, the first frame and the third frame comprise: a beacon frame, an action frame, a data frame, a multi-AP information update request frame, or a multi-AP information update response frame, a feedback frame to a multi-AP trigger frame, etc.

In an embodiment, after step 2804, process 2800 may further include receiving, by the first AP, a fourth frame announcing the fourth multi-AP transmission scheme for the coordinated AP set determined based on the second multi-AP transmission scheme and the third multi-AP transmission scheme. In an embodiment, the fourth multi-AP transmission scheme is the same as the second multi-AP transmission scheme or the third multi-AP transmission scheme or different from the second multi-AP transmission scheme and the third multi-AP transmission scheme.

In an embodiment, the transmitting of the first frame occurs during a setup phase of the coordinated AP set. In an embodiment, the transmitting of the first frame occurs after a setup phase of the coordinated AP set.

In an embodiment, the indication of the first multi-AP transmission scheme indicates no preference for a multi-AP transmission scheme. In an embodiment, the indication of the preferred multi-AP transmission scheme indicates coordinated spatial reuse (CSR), coordinated transmission opportunity (C-TXOP), coordinated time-division multiple-access (C-TDMA), coordinated frequency-division multiple-access (C-FDMA), coordinated beamforming (CBF), joint transmission (JT), or joint reception (JR), etc.

What is claimed is:

1. A first access point (AP) comprising:
one or more processors; and
memory storing instructions that, when executed by the one or more processors, cause the first AP to:
receive, from a second AP, a first frame comprising an indication of a first multi-AP transmission scheme for use in a coordinated AP set comprising the first AP and the second AP; and
transmit a second frame announcing a second multi-AP transmission scheme determined based on the first multi-AP transmission scheme indicated in the first frame.

2. The first AP of claim 1, wherein the first multi-AP transmission scheme corresponds to a preferred multi-AP transmission scheme for the second AP for use in the coordinated AP set.

3. The first AP of claim 1, wherein the second multi-AP transmission scheme is the same as the first multi-AP transmission scheme.

4. The first AP of claim 1, wherein the second multi-AP transmission scheme is different from the first multi-AP transmission scheme.

5. The first AP of claim 1, wherein the instructions, when executed by the one or more processors, further cause the first AP to:
receive, from the second AP, a third frame comprising an indication of a third multi-AP transmission scheme for the coordinated AP set; and
transmit a fourth frame announcing a fourth multi-AP transmission scheme determined based on the second multi-AP transmission scheme and the third multi-AP transmission scheme.

6. The first AP of claim 5, wherein the third multi-AP transmission scheme is an update of the first multi-AP transmission scheme for the second AP.

7. The first AP of claim 1, wherein the instructions, when executed by the one or more processors, further cause the first AP to:
receive, from a third AP, a third frame comprising:
an indication of a third multi-AP transmission scheme for the coordinated AP set comprising the first AP, the second AP, and the third AP;
determine a fourth multi-AP transmission scheme for the coordinated AP set based on the first multi-AP transmission scheme and the third multi-AP transmission scheme; and
transmit a fourth frame announcing the fourth multi-AP transmission scheme.

8. The first AP of claim 7, wherein the fourth frame is the second frame.

9. The first AP of claim 7, wherein the third frame is received after the transmitting of the second frame.

10. The first AP of claim 7, wherein the third frame is received less than a beacon interval after the receiving of the first frame.

11. A first access point (AP) comprising:
one or more processors; and
memory storing instructions that, when executed by the one or more processors, cause the first AP to:
transmit, to a second AP, a first frame comprising:
an indication of a first multi-AP transmission scheme for use in a coordinated AP set comprising the first AP and the second AP; and
receive, from the second AP, a second frame announcing a second multi-AP transmission scheme for the coordinated AP set determined based on the first multi-AP transmission scheme indicated in the first frame.

12. The first AP of claim 11, wherein the instructions, when executed by the one or more processors, further cause the first AP to:
transmit, to the second AP, a third frame comprising:
an indication of a third multi-AP transmission scheme for the coordinated AP set; and
receive, from the second AP, a fourth frame announcing a fourth multi-AP transmission scheme for the coordinated AP set determined based on the second multi-AP transmission scheme and the third multi-AP transmission scheme.

13. The first AP of claim 12, wherein the third frame is transmitted at least a beacon interval after the transmitting of the first frame.

14. The first AP of claim 12, wherein the first frame and the third frame comprise a beacon frame or an action frame.

15. The first AP of claim 12, wherein the third frame is transmitted less than a beacon interval after the transmitting of the first frame.

16. A non-transitory computer-readable medium comprising instructions that, when executed by one or more processors of a first access point (AP), cause the first AP to:
receive, from a second AP, a first frame comprising an indication of a first multi-AP transmission scheme for use in a coordinated AP set comprising the first AP and the second AP; and
transmit a second frame announcing a second multi-AP transmission scheme determined based on the first multi-AP transmission scheme indicated in the first frame.

17. The non-transitory computer-readable medium of claim 16, wherein the first multi-AP transmission scheme corresponds to a preferred multi-AP transmission scheme for the second AP for use in the coordinated AP set.

18. The non-transitory computer-readable medium of claim 16, wherein the instructions further cause the first AP to:
receive, from a third AP, a third frame comprising:
an indication of a third multi-AP transmission scheme for the coordinated AP set comprising the first AP, the second AP, and the third AP;
determine a fourth multi-AP transmission scheme for the coordinated AP set based on the first multi-AP transmission scheme and the third multi-AP transmission scheme; and
transmit a fourth frame announcing the fourth multi-AP transmission scheme.

19. The non-transitory computer-readable medium of claim 18, wherein the fourth frame is the second frame.

20. The non-transitory computer-readable medium of claim 18, wherein the third frame is received after the transmitting of the second frame.
